(19) United States
(12) Patent Application Publication
(10) Pub. No.: US 2006/0041613 A1
(43) Pub. Date: Feb. 23, 2006

(54) Method and system for visual art distribution and presentation

(76) Inventors: Jonathan Robert Ordway Fackelmayer, Chicago, IL (US); Joshua Robert Kaufman, Chicago, IL (US)

Correspondence Address: BEEM PATENT LAW FIRM, 53 W. JACKSON BLVD., SUITE 1352, CHICAGO, IL, 60604-3787, US

(21) Appl. No.: 10/920,573

(22) Filed: Aug. 18, 2004

(51) Int. Cl. G06F 15/16

(52) U.S. Cl. 709/203

(57) ABSTRACT

A method and system is described for enabling the exposure, distribution and presentation of high quality digital representations of images of visual art works to customers and entails infrastructure for storage, management, selection, and retrieval of one or more images of visual art, storing selected images in a portable storage medium, and distributing the medium to a customer. In addition, a display device assembly enables the customer to obtain and display high quality digital representations of these art works. The device has technology which allows it to read images stored on the portable medium and present the image in a high resolution, full screen format.

### BACKGROUND OF THE INVENTION

1. Field of the Invention

A method and a system are described for enabling the exposure, distribution and presentation of high quality digital representations of images of visual art works to customers.

2. Description of the Related Art

Computing technology has made it possible to allow images of visual art to be digitally represented, stored, read and displayed on a computer device such as a personal computer. With the advent of the Internet, even minor inconveniences of physical image transport are overcome by providing a global conduit for electronic active or passive accessibility. One may actively share by initiating delivery of the image. Passive accessibility allows the image holder to share the image with anyone simply by electronically connecting to the network and allowing permission for the image to be shared. Moreover, with commonly available digital image creation mechanisms, such as digital cameras, or computer software tools, such as desktop publishing applications, anyone has the capacity to create digital images. Though this adds to the vast contribution of images for public consumption, it varies the degree of image quality and dilutes the selection of choice art.

Image exposure and distribution in the unregulated electronic environment of the Internet exacerbates the problem of unauthorized image reproduction. Vast public accessibility dampens image quality by allowing the original image to be digitally manipulated by anyone, often occurring behind an unwitting image owner. The level of insecurity, the lack of technical knowledge, and unsuccessful efforts to maintain select art and quality control are large reasons why the art world has been hesitant to recognize digital images of visual art as a respected art medium.

There are currently several digital technology providers in the image display market. The main purpose for their devices has been to offer consumers a convenient way to display the images they captured with their digital cameras, such as family events, vacations and social gatherings. Recently, some of these providers are differentiating their products from competitors by offering additional features such as Internet-based content and album management tools. Their products are geared toward home and private office use, similar to its predecessor, the prosaic picture frame.

Today's systems may not be geared towards cost-effectively presenting high quality images of visual arts. In one extreme, today's high-powered multimedia systems such as plasma display-based High Definition Televisions (HDTV) make use of Field Programmable Gate Array (FPGA) technology to present images with exceptional quality. These systems are rich with entertainment features but are quite expensive. In the other extreme, limited purpose FPGA-based devices are available at much lower cost but may not be robust enough for handling high quality images. For example, an automotive entertainment console may use a low cost Altera FPGA to display information to the user. The main sub-systems of the Altera are known to run at 50 MHz, however, this speed may not be adequate to effectively access and display high-quality images.

There have been a few attempts to provide technology for digital image presentation of both privately owned and publicly available images of visual art. Flat panel display devices, commonly referred to as “digital picture frames,” have been developed and offered for sale. Some digital image content providers are known to have vast collections of photography, fine art and illustrations. These collections are stored in large databases and accessed using software which typically operates in a networked, computing environment. Specific images are usually electronically distributed to their desired location in response to a request.

Between the digital image display providers and the image content providers, no one has been able to provide a total solution for exposure, distribution and presentation of high quality digital representations of images of visual art artworks to customers. Moreover, none have addressed the concerns of the art world regarding technology's perceived failure to provide secure, high quality, and choice images in a controlled yet accessible electronic environment. What is needed is a total solution wherein the technology exposes a rich selection of cataloged images, responsively distributes images from a collection of databases to a customer, and presents the images in extraordinary clarity, color vitality, and crisp texture recognition via an illuminated display device assembly.

### SUMMARY OF THE INVENTION

The invention is directed to providing a method and apparatus for exposure, distribution and presentation of high quality digital representations of images of visual art artworks to customers. The customer is provided with a display assembly resembling a digital picture frame and access to an Internet terminal with a web store. Initial, content exposure is accomplished through providing software that may function on personal computers connected to the Internet. Exposure to the public may be achieved by having a computing platform-independent web client operating through the aid of an Internet browser and maintaining a networked session with a remote server. Hence, a web client capitalizes on public accessibility of an Internet-connected computer. Through the terminal, the customer is able to browse for desired images, make a selection and place an order for the selection. The order is realized by triggering image management infrastructure to retrieve the selection. The infrastructure processes the customer transaction, creates a customized collection of one or more ordered images, and loads the collection in a storage medium. The medium is then delivered to the customer. The delivery of the medium to the target customer constitutes the distribution portion of the invention. When the storage medium is received, the customer inserts the medium into a display assembly. The image is read from the medium and displayed to the customer in a high quality, visualized representation on a display device.

In other aspects, exposure may be accomplished manually such as by providing a catalog of images which may be replicated to impart the same degree of public accessibility as the web store in an Internet terminal. The customer may select an image from the catalog and communicate with staff to request an order. Both exposure scenarios are meant to enable the same triggering mechanism for image selection retrieval. Distribution may also be in the form of delivering the display assembly and storage medium to the customer with one or more selected images already loaded into the medium. Presentation may be accomplished in other ways both electronically and mechanically. Electronically manifested examples may be that, for multiple images on the medium, each image is read and displayed for a variable or fixed duration. As another example, all images may be displayed at the same time on different areas of the display screen. On a mechanical aspect, the image display screen itself may be physically reoriented based on customer presentation preference or image requirements, rotating the screen ninety degrees for example.

### BRIEF DESCRIPTION OF DRAWINGS

The invention may best be understood by reference to the following description taken in conjunction with the accompanying drawings in which:

FIG. 1 is a diagram illustrating an interaction between the customer and the invention.

FIG. 2 is a diagram illustrating an image management infrastructure in greater detail and depicts context as illustrated in FIG. 1.

FIG. 3 is a diagram showing a technical architecture used to realize the image management infrastructure.

FIG. 4 is a diagram illustrating an integration layer (Java) in greater detail and depicts context though integration layer interaction with databases and web store.

FIG. 5 is a block diagram illustrating the major components making up a display assembly.

FIG. 6 is a perspective drawing conceptualizing the inserting of a storage medium into the display assembly.

FIG. 7 shows a dedicated single board controller for the display assembly.

FIG. 8 is a summary of tables for the customer and product databases.

FIG. 9A is a detailed set of summary tables for customer and product databases.

FIG. 9B is a continued detailed set of summary tables for customer and product databases.

FIG. 9C is a continued detailed set of summary tables for customer and product databases.

FIG. 10A is a set of MySQL programming code segments for customer and product databases.

FIG. 10B is a continued set of MySQL programming code segments for customer and product databases.

FIG. 10C is a continued set of MySQL programming code segments for customer and product databases.

FIG. 10D is a continued set of MySQL programming code segments for customer and product databases.

FIG. 10E is a continued set of MySQL programming code segments for customer and product databases.

FIG. 10F is a continued set of MYSQL programming code segments for customer and product databases.

FIG. 10G is a continued set of MySQL programming code segments for customer and product databases

FIG. 11 is a block diagram overview of the major sub-systems making up the controller.

FIG. 12A is a schematic of the Power sub-system.

FIG. 12B is a continued schematic of the Power sub-system.

FIG. 13 is a schematic of the Serial sub-system.

FIG. 14A is a schematic of the Compact Flash Interface sub-system.

FIG. 14B is a continued schematic of the Compact Flash Interface sub-system.

FIG. 14C is a continued schematic of the Compact Flash Interface sub-system.

FIG. 15A is a schematic of the to Low Voltage Differential Signaling (LVDS) sub-system.

FIG. 15B is a continued schematic of the to Low Voltage Differential Signaling (LVDS) sub-system.

FIG. 15C is a continued schematic of the to Low Voltage Differential Signaling (LVDS) sub-system.

FIG. 16 is a schematic of the Synchronous Dynamic Random Access Memory (SDRAM) sub-system.

FIG. 17 is a schematic of the Static Random Access Memory (SRAM) sub-system.

FIG. 18A is a schematic of the Flash sub-system.

FIG. 18B is a continued schematic of the Flash sub-system.

FIG. 19A is a schematic of the Field Programmable Gate Array (FPGA) 126 to sub-systems connectivity.

FIG. 19B is a continued schematic of the Field Programmable Gate Array (FPGA) 126 to sub-systems connectivity.

FIG. 19C is a continued schematic of the Field Programmable Gate Array (FPGA) 126 to sub-systems connectivity.

FIG. 19D is a continued schematic of the Field Programmable Gate Array (FPGA) 126 to sub-systems connectivity.

FIG. 20A is a schematic of the connection scheme for FPGA programming and operation.

FIG. 20B is a continued schematic of the connection scheme for FPGA programming and operation.

FIG. 20C is a continued schematic of the connection scheme for FPGA programming and operation.

### DETAILED DESCRIPTION OF THE ILLUSTRATED EMBODIMENTS

1. Process Overview

In the following description, numerous specific details are set forth to provide a thorough understanding of the present invention. However, it will be apparent to one skilled in the art, upon reading the following description, that the present invention may be practiced without every specific detail.

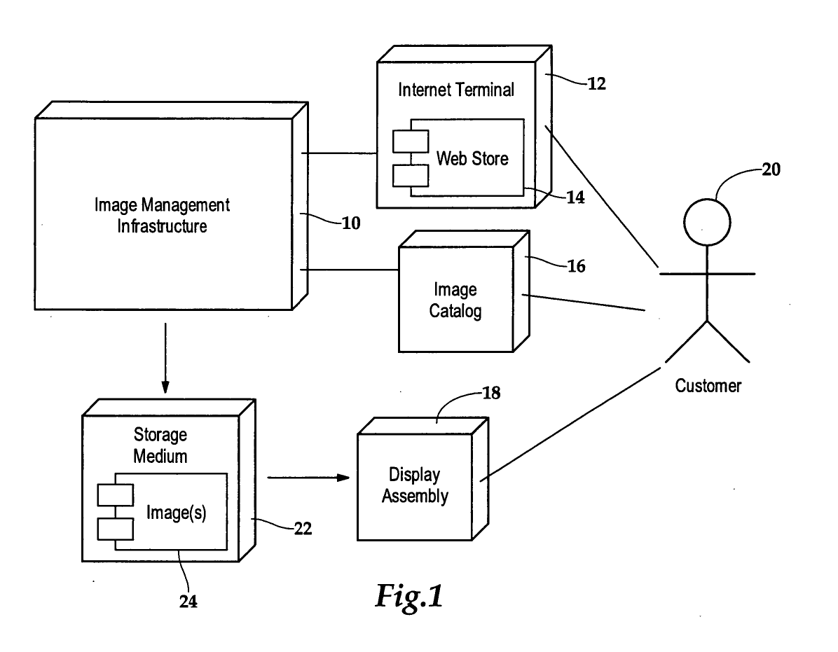

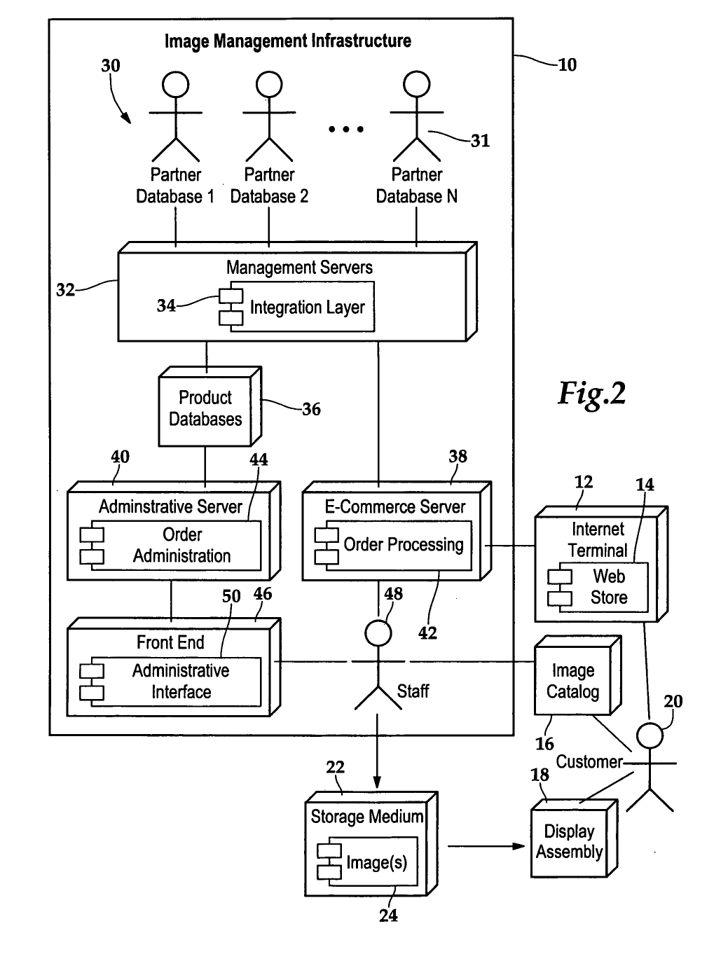

In FIG. 1, a customer 20 is provided with a display assembly 18 resembling a digital picture frame and access an Internet terminal 12 with a web store 14. A computing platform-independent web client operates through the aid of an Internet browser called a web store 14 and maintains a networked session with a remote e-commerce server 38 (see FIG. 2). Through the terminal 12, the customer 20 is able to browse for desired images, make a selection and place an order for the selection. The order is realized by triggering image management infrastructure 10 to retrieve the selection. The infrastructure 10 processes the customer transaction, creates a customized collection of one or more ordered images 24, and loads the collection in a storage medium 22. The medium 22 is then delivered to the customer 20.

1.1 Image Customer Exposure

Internet-enabled exposure to allow the infrastructure 10 to retrieve an image from a partner database 31 and store one or more images 24 for delivery is accomplished in a customer-oriented client-server scheme involving cooperative operations between the Internet terminal 12 and the e-commerce server 38. On the client side, the Internet terminal 12 runs a web store 14 which provides the customer 20 with the ability to view one or more of the images from an Internet terminal 12 in miniature, “thumbnail” or enlarged form, and displays the images in one or more groupings for customer 20 search and image selection purposes. Searching may be performed by selectable categories or by keyword. A customer 20 may select a specific category of images from a list of categories on the graphical user interface of the web store 14. Sample categories may be grouped by artists' last name, art subject, top ten most requested art or list of art, artwork title in alphabetical order and the like. Once the specific category is chosen, a grouping of thumbnail images classified under the selected category is presented to the user. In addition, the web store 14 is capable of dynamically displaying information for business purposes such as a bestsellers list, specials, and new products. The keyword search involves entering a key word into an edit box of the graphical user interface and triggering a search command so that an underlying search engine may look for the closest grouping of images that are most closely associated to the key word. The resulting search displays the images to the customer 20. The search engine is optimized for the web store 14, that is, it performs the commanded search in an efficient manner.

The web store 14 may also have provisions for account administration as a customer convenience option. With this option the customer 20 is able to create a web store account, create and manage an account password, log in and log out of the account, view and change account information, view past and pending orders, subscribe to a mailing list, and enter demographic information. In addition, the web store 14 features address book administration capabilities, namely, the ability for a customer 20 to store primary and alternate shipping addresses, modify address book entries, and delete entries.

1.2 Image Order Processing

Order processing 42 of customer-selected images 24 entails a multitude of functionalities on the web store 14. The graphical user interface employs a “Shopping Cart” metaphor for placing image orders. “Add items to cart” allows the customer 20 to place items in a virtual “shopping cart” as a desired image is encountered. “Remove items from cart” allows one to dispense with an image no longer in purchase consideration. For each item in the shopping cart the customer 20 may specify the desired purchase quantity. The customer 20 is able to make a selection to view cart contents. Once the customer 20 is ready to place carted items on order, he then proceeds to “check out” the order. The graphical user interface presents a series of prompts for information, allowing the customer 20 to enter delivery address information, preferences for how to ship ordered items, and credit card payment information. Once all the pertinent information is entered, the user interface displays an order confirmation page which includes items such as order pricing, shipping cost and tax. An order confirmation mechanism such as the sending of an email is provided to the customer 20 after the described transactions have been made.

On the server side, the e-commerce server 38 is operated by staff 48 to process the order from the customer 20 transaction. The customer 20 requests ordered images 24 from a variety of independent image collections residing in databases, known as partner databases 30. Staff 48 uses the e-commerce server 38 to implement the customer request by acquiring the image 24 and enabling transfer to a portable storage medium 22. Once the selected image. 24 is loaded onto the storage medium 22, the medium 22 is then shipped to the customer 20.

There are options regarding the level of automation possible for the order fulfillment process ranging from the least automated to the most. The least automated would still employ automatic invoice generation. However, image retrieval from a partner database 31 would be a staff function. One such process would involve staff 48 invoking an image file transfer from a command console using a protocol such as file transfer protocol (FTP). In a model use of physical delivery, Staff 48 would package and apply a shipping label on each image-loaded medium 22 by hand and manually invoke an “Order ship confirmation” email just prior to delivery. A more automated process would still involve automatic invoice generation. In contrast to the least automated process, electronic file transfer would take place once a proper order was placed from the web store 14 by the customer 20. Staff 48 would package and apply the shipping label on each image-loaded medium 22 and invoke an “Order ship confirmation” email just prior to delivery. In the most automated scenario, all processes are automated: invoice generation, electronic file transfer invocation, shipping label creation and application on the medium 22, and sending of the “Order ship confirmation” email.

1.3 Image Delivery

Delivery may be accomplished in many ways ranging from the elegantly simple to the most technologically advanced depending on customer and business needs. Staff may simply prepare the loaded storage medium for physical delivery such as through a mail and package carrier. On the more technology-leveraged side, delivery can be performed using wired or wireless platforms such as the Internet or high-speed cellular technologies like Third Generation, or 3G, wireless. When the storage medium 22 is received, the customer 20 inserts the medium 22 into an input device 300 of the display assembly 18 (see FIG. 6). The image 24 is read from the medium 22 by the display assembly 18 and presented to the customer 20.

2. Image Management Infrastructure

The image management infrastructure 10 is a hosting environment for supporting image exposure and distribution. The environment comprises one or more of the following hardware: a hosted server, a firewall, and a backup system. The hosted server primarily runs application and web services. One example of a hosted server is a Dell Poweredge 750. The firewall is staged between the environment and the internet for network security purposes. The backup system provides recovery of critical data in the event of computer disk failure, data corruption, or data loss.

On the software side, the environment comprises one or more of the following: a Java virtual machine, a database engine such as MySQL, a web server such as Apache web server, and an operating system such as Linux. The hosted server runs on operating system such as Linux Redhat version 9.0. However, the hosted server can run on other suitable operating systems like Microsoft Windows 2000. The Apache is a collaborative developer community working on open-source software projects, one of which is a popular web server. Similarly, MySQL is an open-source, high-performance database management software that powers web sites, enterprise applications and packaged software applications. A component of the Java runtime environment, a Java virtual machine compiles Java byte codes, manages memory, schedules threads, and interacts with a host operating environment like a web browser running the Java environment.

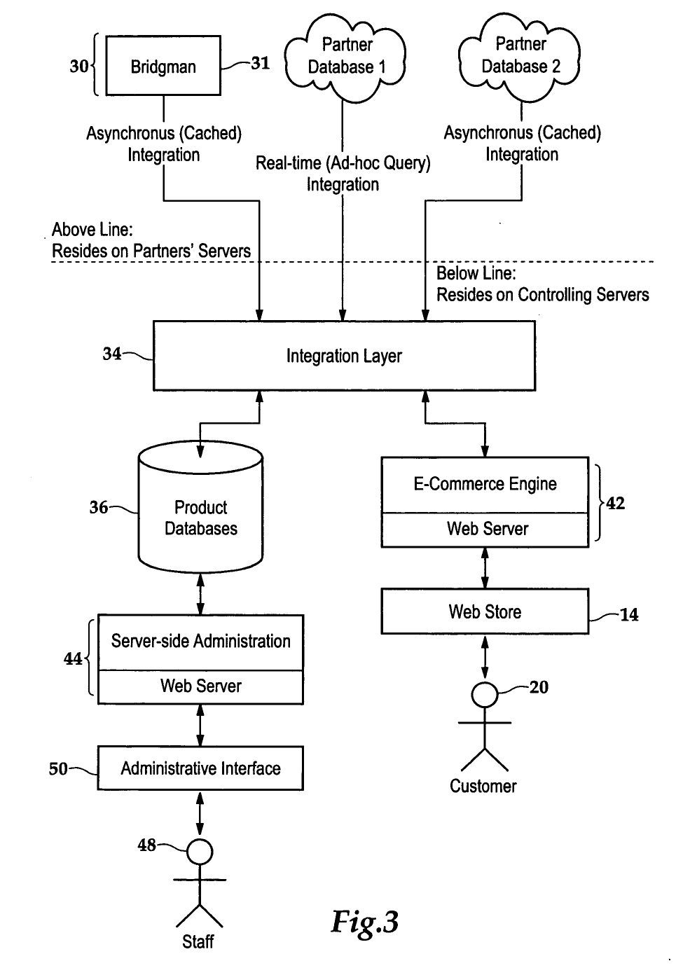

There are a variety of network configurations that may be used to realize image management and delivery. Computing nodes, typically called servers, may have different responsibilities depending on the designed network configuration. A node in one configuration, for example, may be responsible for both administrative and image order processing tasks. On the other hand, for a different configuration, these two tasks may be performed separately by two independent nodes. FIGS. 2 and 3 illustrate one embodiment of the invention encompassing one of many possible network configurations that may be used to realize the image management and delivery.

Though keeping the notion of changeable network configuration, a major part of the embodiment may be broken up into several subsystems: Internet terminal 12, e-commerce server 38, customer and product databases, or product databases 36 for short, partner databases 30, management servers 32, front end 46, and administrative server 40. These components are implemented in the following description.

2.1 E-Commerce Server

The e-commerce server 38 operates using a customized version of third-party software. One such building block is osCommerce, an open-source platform that provides the setup, run and maintenance of an online store such as the web store 14. It is a ready solution whose core technology is PHP. PHP, a recursive acronym for “PHP: Hypertext Preprocessor,” is a widely-used open-source, general-purpose scripting language that is especially suited for web development. A PHP-based e-commerce engine operates on a web server such as the Apache web server. To coincide with osCommerce, the e-commerce server 38 also utilizes third-party software modules for sales tax capability, and shipping cost. Furthermore, a payment gateway provides for validation and reconciliation of credit card payment. Note that other general-purpose scripting languages may also be a capable substitute for PHP. Java, Tcl, Python and Perl-based scripting languages, for example, are equally suitable PHP replacements. Similarly, osCommerce is one of many application-level, e-commerce solutions available. Other solutions include TurboShop from Digivate and similar e-commerce application alternates.

2.2 Partner databases

Partner databases 30 are digital libraries of images of visual art drawn from collections representing art works typically originating in physical form such as a painting on canvas or a photograph. These works are scanned by a computer and transformed into a digitized representation which may be later displayed on a digital picture frame. Each partner database 31 is an independent digital library commonly managed by digital art collectors, usually referred to as “content providers”, and made available online via the Internet. Each collector usually implements their own form of image management service for the public such as the ability to search for specific art work and report accompanying information regarding the work, its history, and the artist. A partner database 31 allows compatible computing environments to electronically acquire copies of individual images. The Bridgman Art Library is one example of a partner database 31.

2.3 Management Servers

The management servers 32 provide a central platform for integrating one or more independent partner databases 30 with varying communication interface mechanisms. There are a plurality of heterogeneous database management solutions that may operate to fulfill the management servers 32 role. Quest Software, Inc. has released one such a solution. Called Quest Central for Databases, the solution provides major database applications such as Oracle and Database-2 (DB2) a cross-platform interface for management and functional support.

2.3.1 Integration Layer

Another equally suitable heterogeneous database management solution is the integration layer 34. The integration layer 34 implements a robust and extensible communication between the e-commerce server 38, product databases 36 and partner databases 30. The extensibility is accomplished by the layer's ability to integrate with content providers employing different database vendors, database schemas, and data encodings. Examples of data encoding is Unicode and a foreign character set. It also facilitates a Java-based, heterogeneous database environment designed to accommodate different ways of access to partner databases 30.

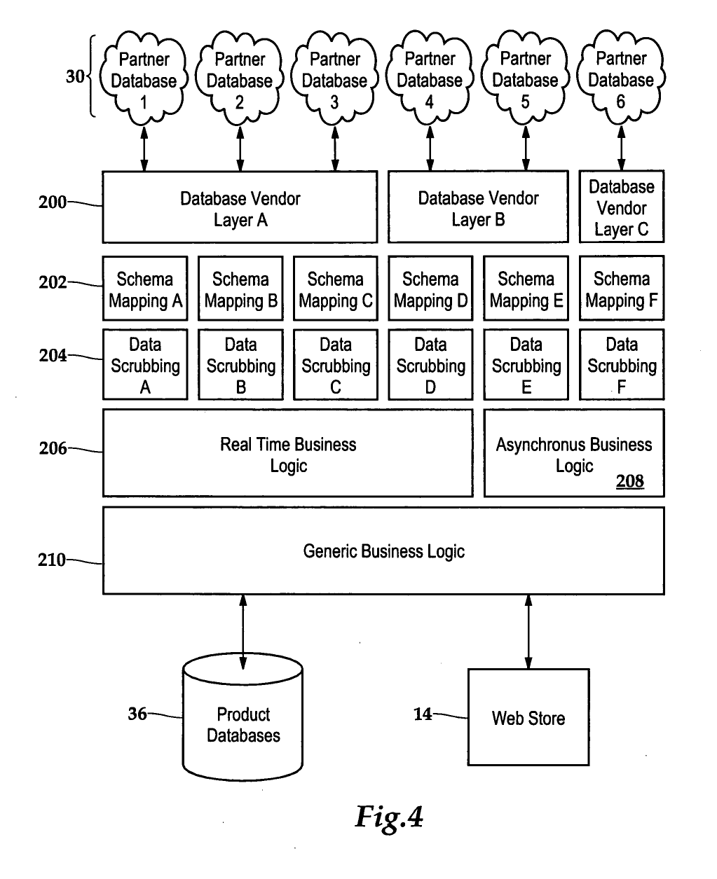

Referring to FIG. 4, the integration layer 34 is comprised of several components: database vendor layer 200, schema mapping 202, data scrubbing 204, real-time business logic 206, asynchronous business logic 208, and generic business logic 210. The database vendor layer 200 is responsible for implementing provider-specific database access mechanisms. As illustrated, database layer vendor A, B and C represent three different database access mechanisms. Partner databases 1, 2 and 3 employ one type of mechanism. Partners 4 and 5 are accessed in a different manner. Partner VI is accessed using still another mechanism. In schema mapping, a source database is mapped into a target a description of the structure of a specific data item. It involves the discovery of a query or set of queries that transform the set of data into this new structure. Once the image is acquired from a partner database 30, an image's attributes are mapped to the integration layer defined schema.

Data scrubbing 204 is the process of fixing or eliminating individual pieces of data that are incorrect, incomplete or duplicated before the data is passed to one of the business logic applications. Its goal is also to bring consistency to various data sets that may have been created with different, incompatible business rules. Images taken from each partner database are mapped and scrubbed in order to provide useful information to the business logic application. There are two major types of business logic in the integration layer: real-time and asynchronous. Depending on the partner database, images are queried using one of these logic functions. The asynchronous business logic 208 enables periodic access to images from partner databases. Once a set of images is acquired, the set is stored in a queue and an image request is fulfilled by taking the image from the queue. The real-time approach immediately accesses and image from the partner database, circumventing the queue. The generic business logic 210 provides an abstraction layer between the two lower-level, business logic applications, the product databases 36, and the web store 14. This is so that the product databases 36 and the web store 14 need not concern themselves with whether image access is performed in real-time or asynchronously. Similarly, various image access mechanisms may be abstracted from staff 48 since different partner databases 30 have differing ways of image acquisition. As an example, one partner may provide parameters that reference where an image is actually stored. One access mechanism may process these parameters to acquire a copy of the requested image. Another partner database may provide the image in it's entirely through authenticating email transmission. Both these mechanisms may be abstracted from staff 48 by providing extendable, implementation-oriented access components under a higher-level access mechanism.

2.3.2 Image Quality Control

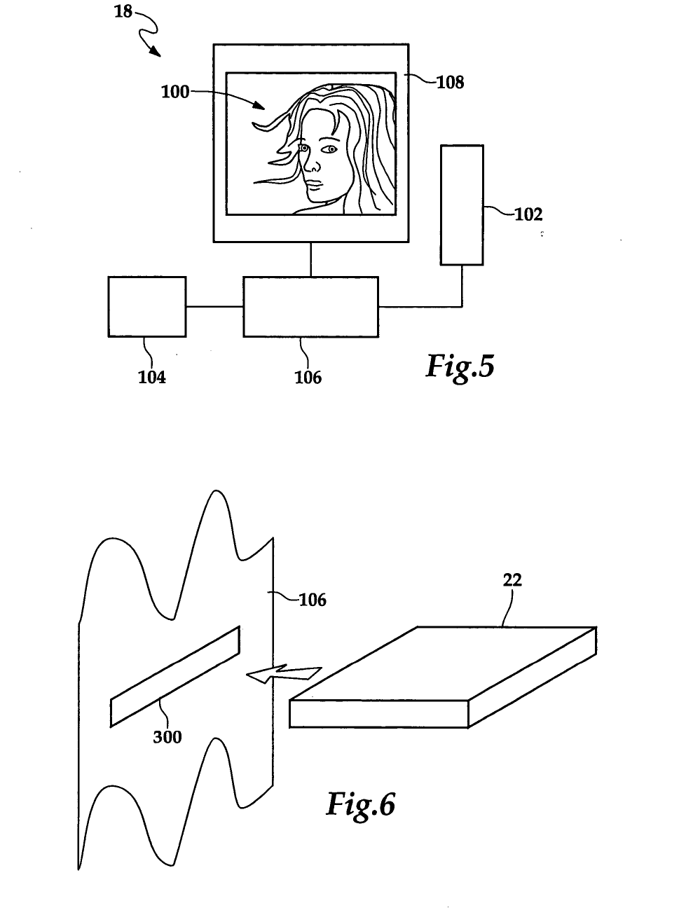

Because management servers 32 control and centralize access to partner databases 30, the image quality is regulated. The servers may integrate with only partner databases that meet a digital image quality standard of having images fitted for the pixel resolution of at least 1024×768 pixels. A more preferred range is from 1280×1024 to 6400×4800. A still more preferred range is from 1152×864 to 3200×2400. In one embodiment, the resolution criteria is 1600×1200. Also, the images are displayed in true proportion relative to the size of a display panel 100 (see FIG. 5). One embodiment features support for display panel sizes of 15, 19 and 23 inches. True proportion is accomplished by having staff 48 digitally size an image on a display using an image editor tool such as Adobe Photoshop. This process is executed while maintaining the quality of image presentation.

2.4 Product Databases

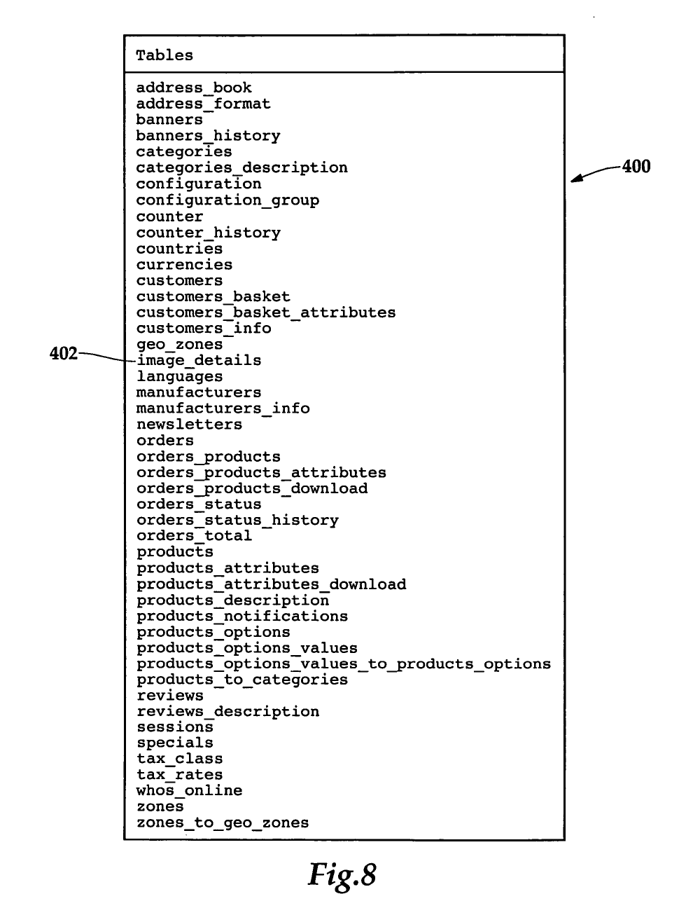

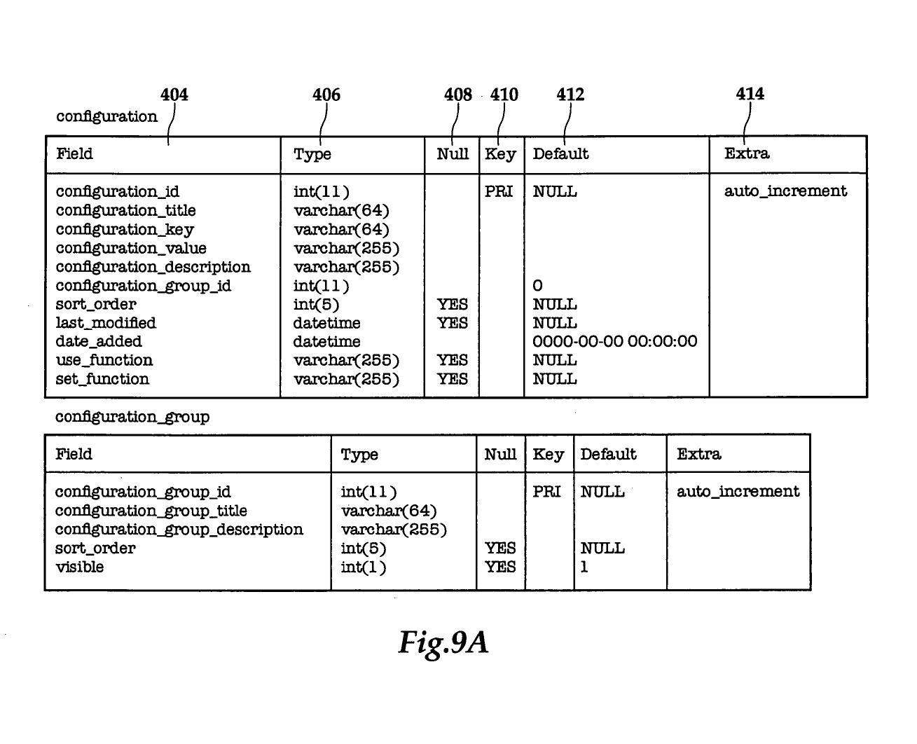

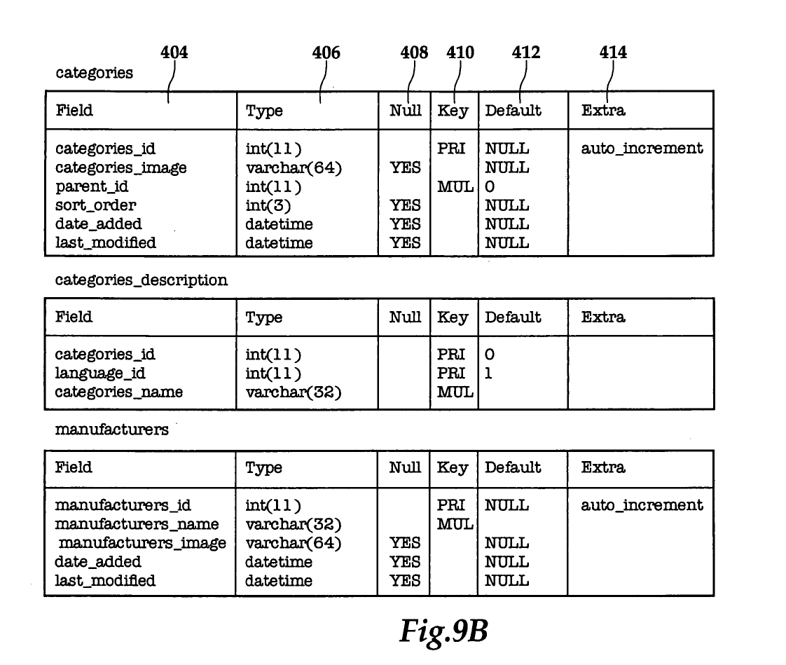

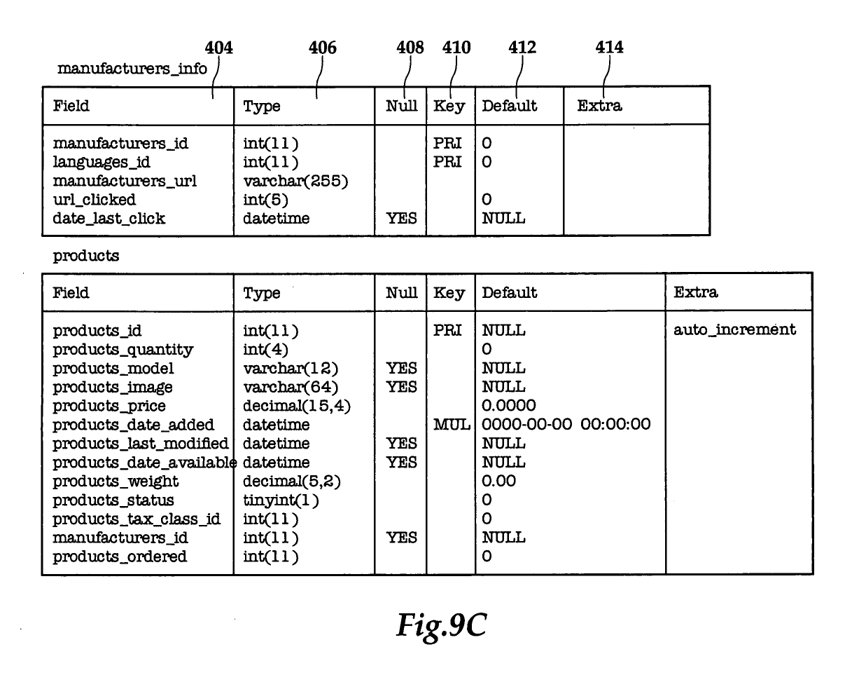

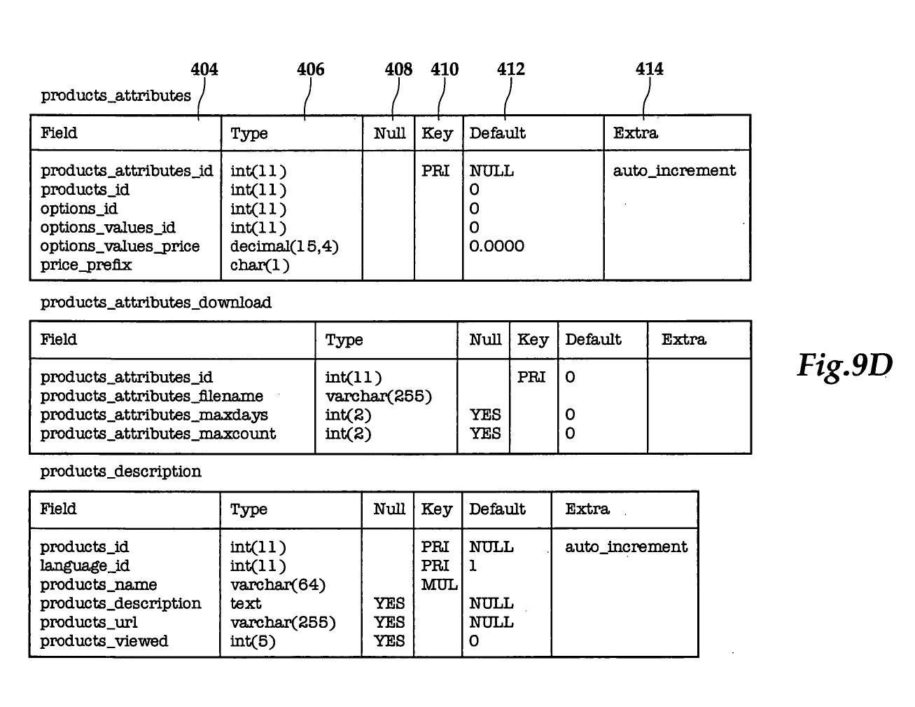

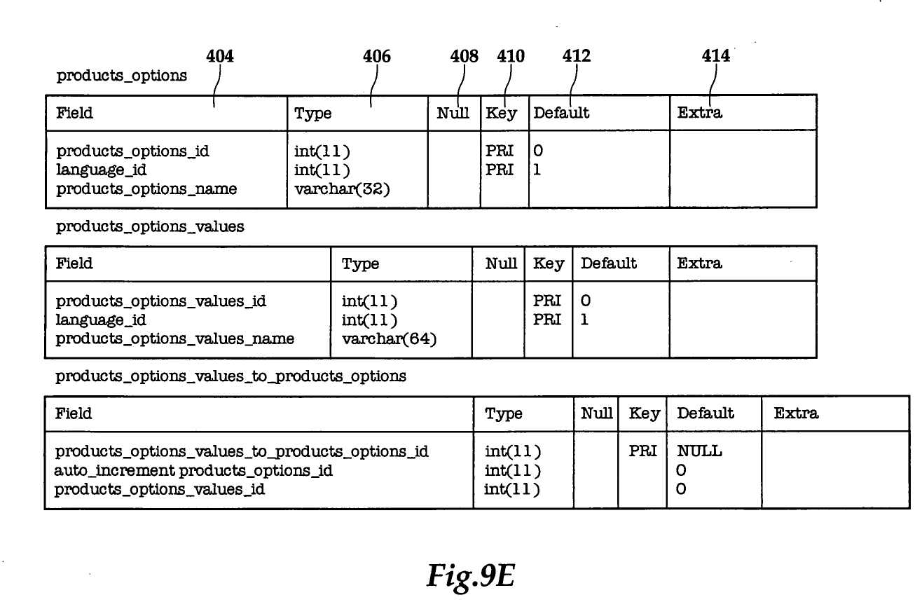

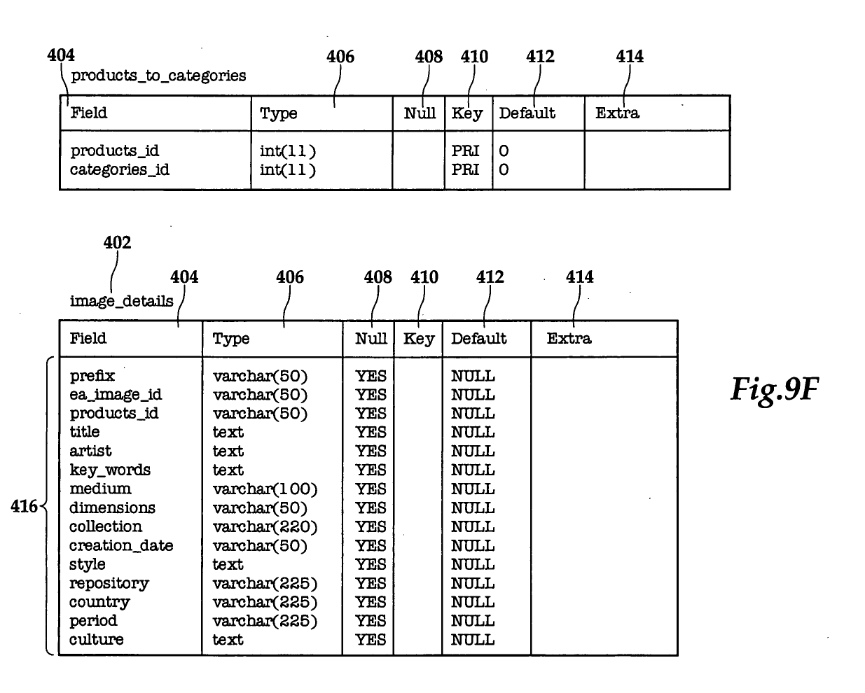

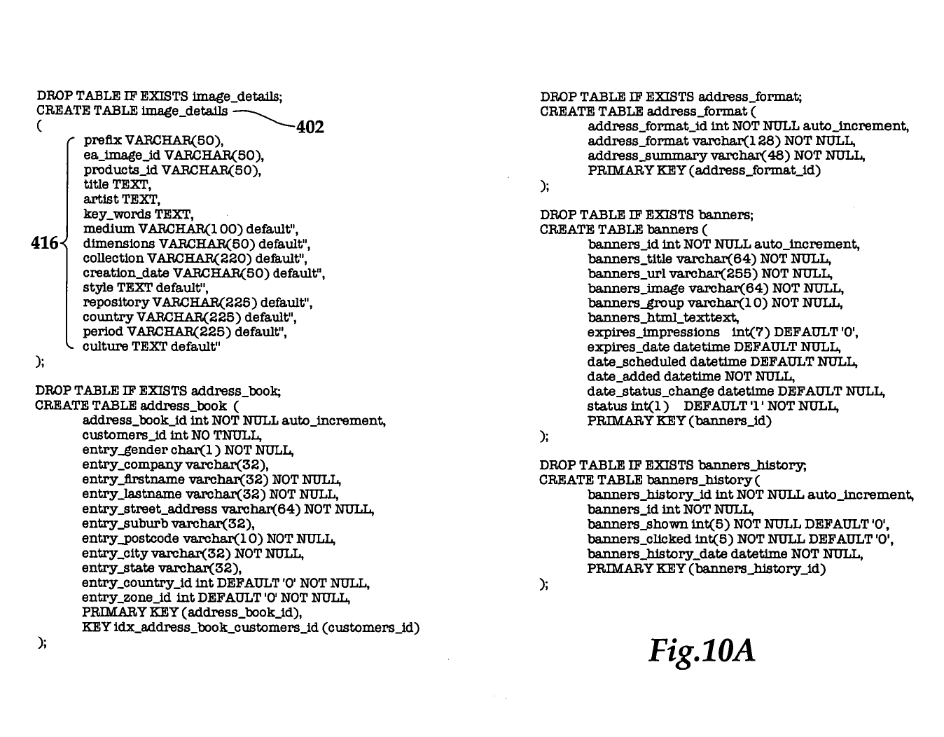

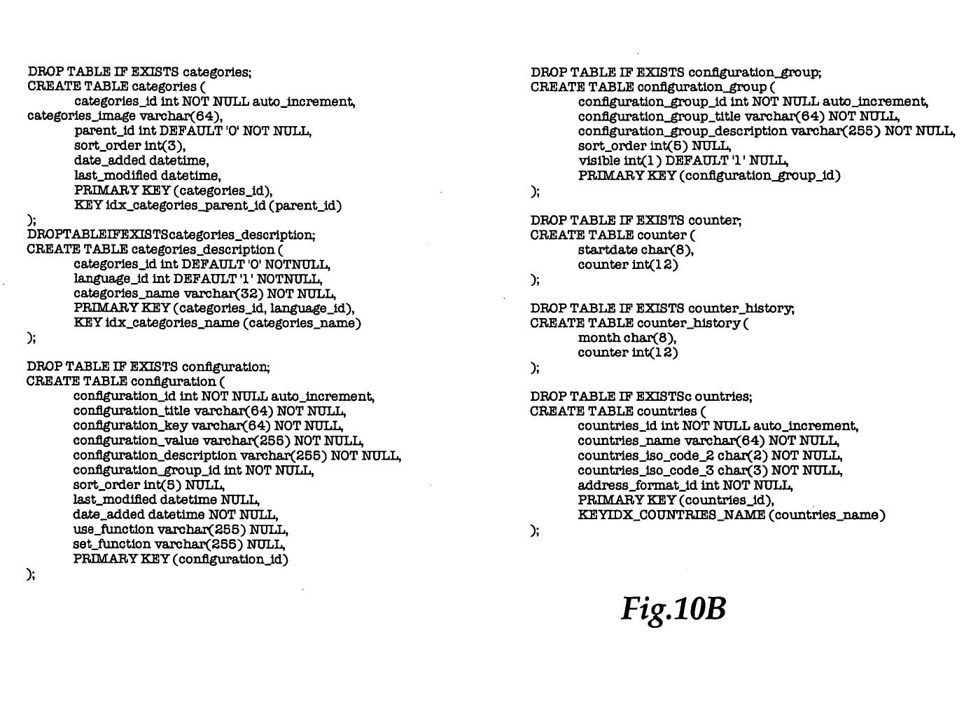

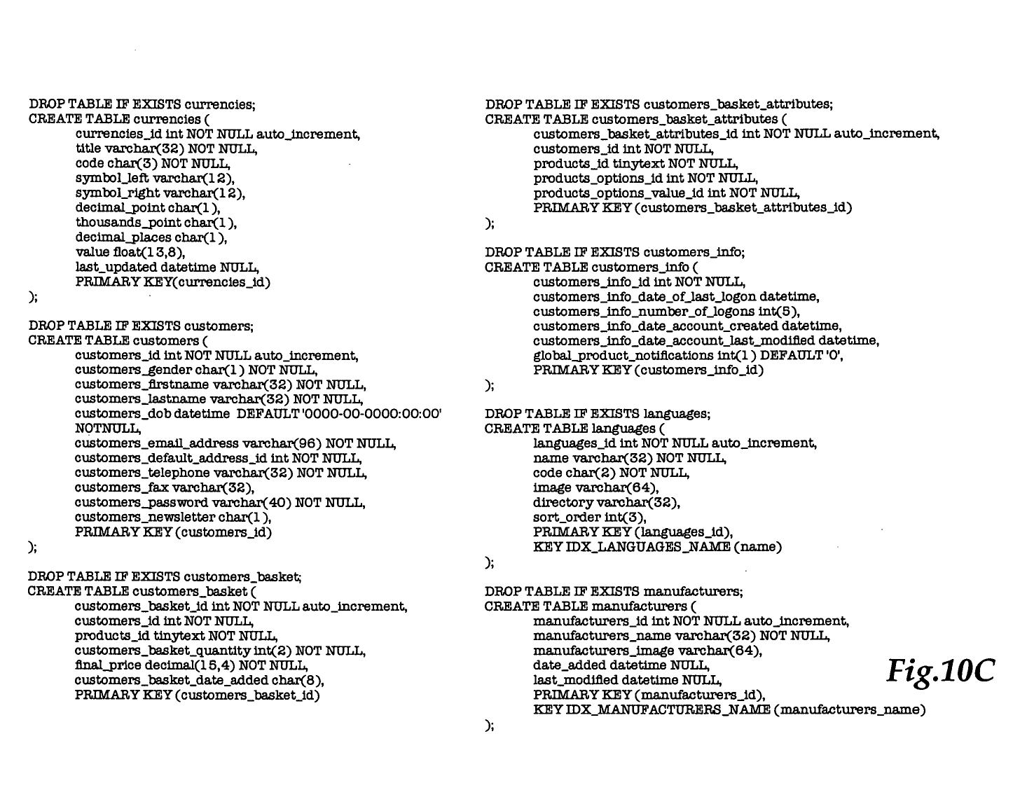

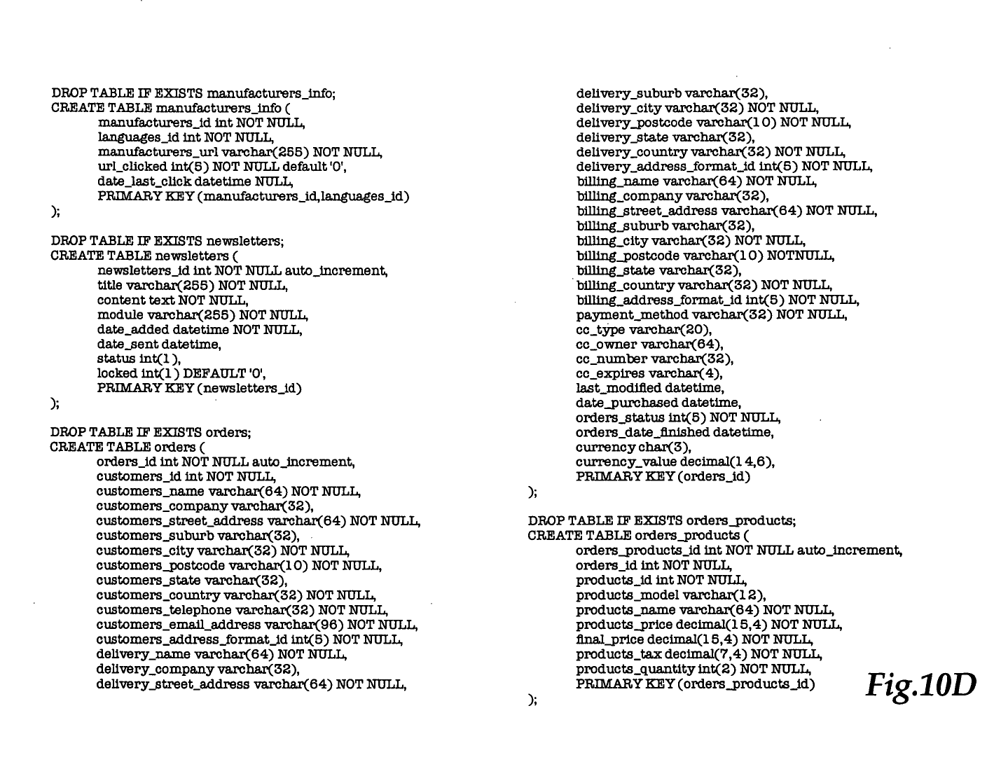

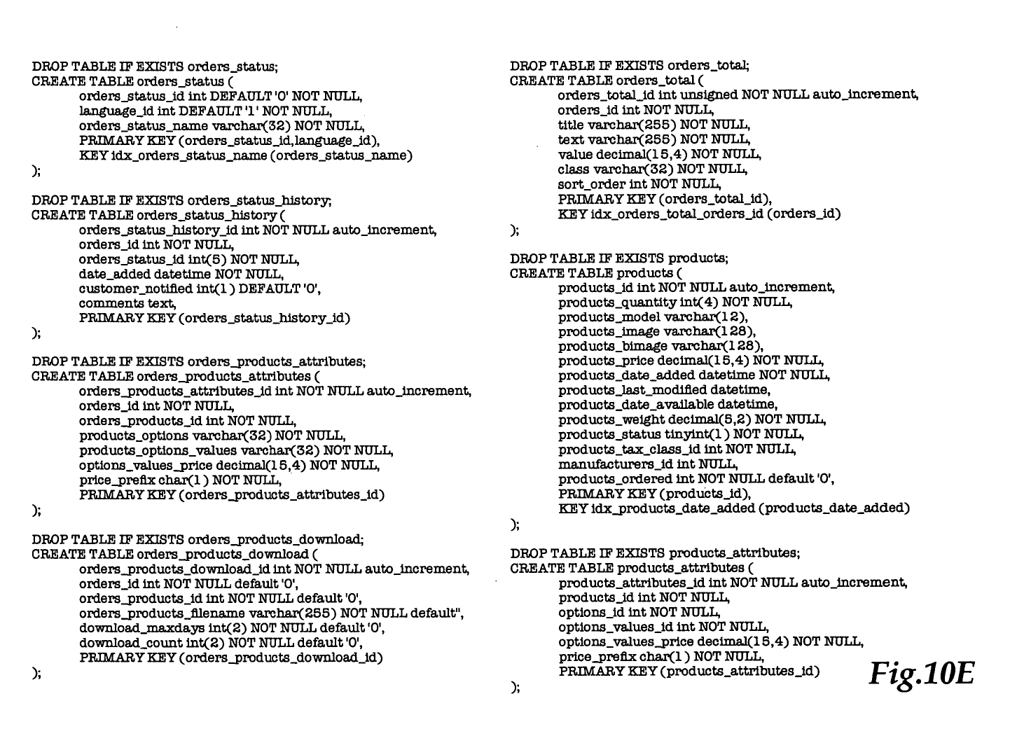

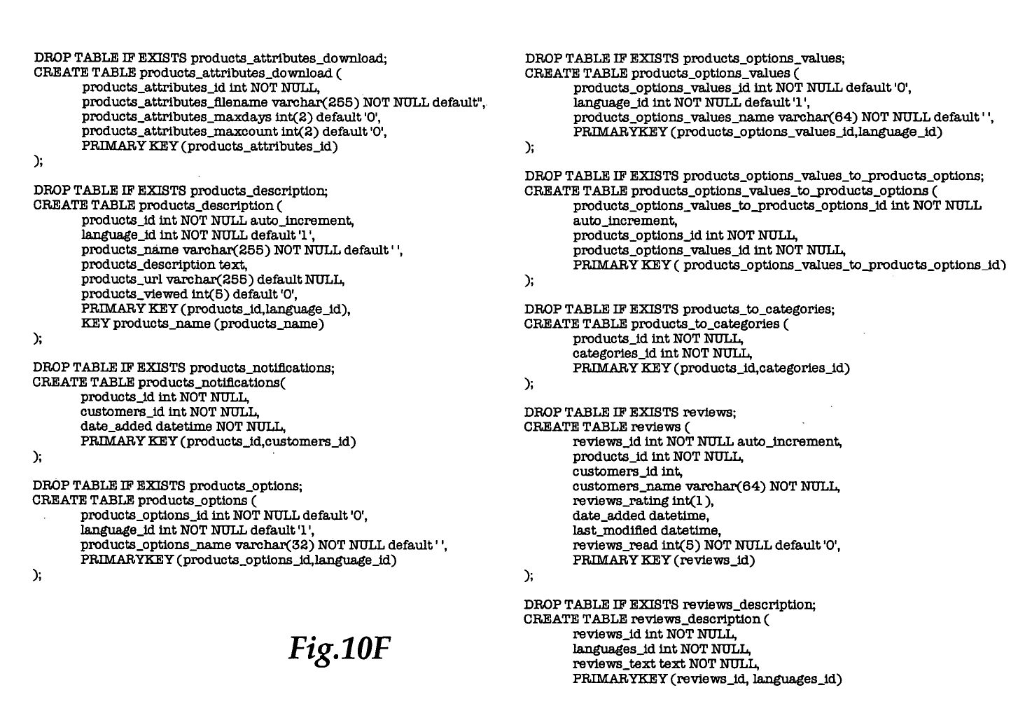

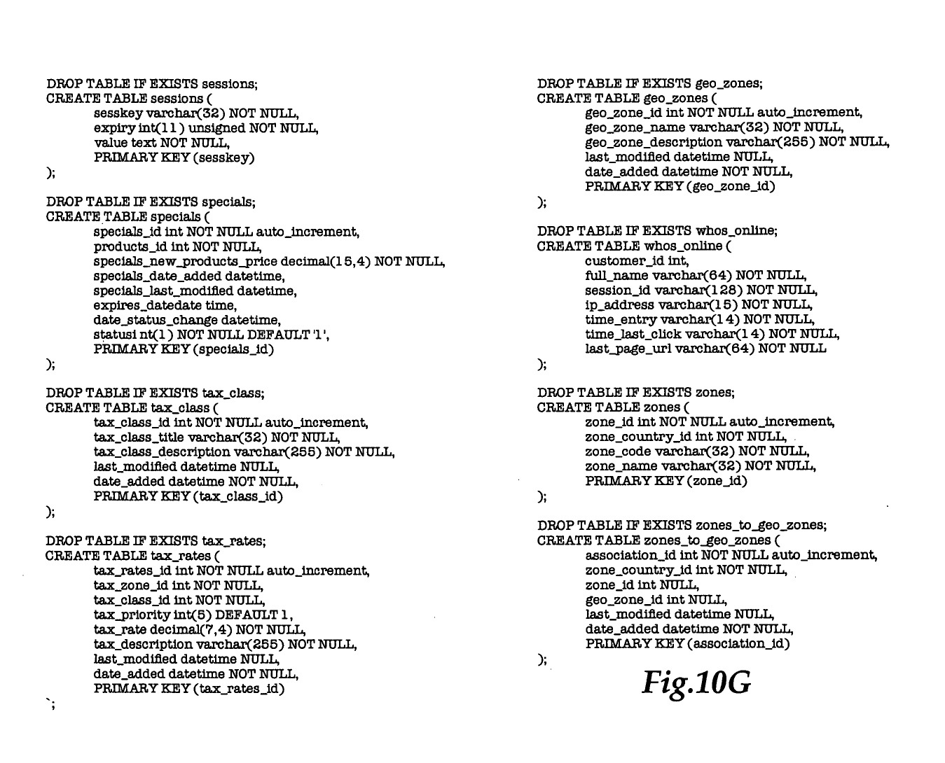

Referring again to FIG. 3, a centralized copy of select images and customer information is maintained in the product databases 36. Managing data from the product databases 36, is accomplished using database tools such as MySQL. FIG. 8, depicts an example summary of tables making up the database. FIG. 9A through 9C provide a sampling of some of the tables with accompanying data structures. FIG. 10A through 10G is the MySQL script used to define the data structures and to aid in the query and store of product databases data. As shown in FIG. 8 for example, a table element called image_details 402, may be broken down into its pertinent data structures. This is shown in FIG. 9F where image_details 402 is comprised of specific elements 416 each having information grouped under a field 404, type 406, null 408, key 410, default 412 and extra 414 property. FIG. 10A depicts the MySQL code segment used to realize this table. As shown, image_details 402 table is created using syntax to define it by its elements 416. A collection of these code segments characterize the product databases 36.

2.5 Image Staff Administration

Administering product databases 36 is achieved using a client and server scheme similar to the customer-oriented client-server approach but targeted for staff operations. On the client side, staff 48 is provided with an administrative interface 50 on the front end 46. Through this interface, staff 48 may add and remove images from an image catalog 16, change image pricing, change image category information, view customer orders, and print business process items such as invoices and packing slips. On the server side, the administrative server 40 provides the computing platform between the staff 48 and product databases 36, wherein residing software performs order administration 44 using PHP-based administrative interface 50 running with a web server such as the Apache web server.

2.6 Image Loader

The mechanism for image loading may be implemented in a number of ways. One way is to have staff 48 operate a graphical user interface that allows one to select one or more images and perform preparation and loading of the images on to the medium or, perhaps, more than one medium at the same time. Another way is for staff 48 to type a command from a command console that runs a script which performs selected image preparation and loading. Image preparation involves reading the image and converting it into a specified graphical image format such as Joint Photographic Experts Group (JPEG) or Tagged Image File Format (TIFF). One of the many ways of implementing graphical image file format conversion is the use of Netbpm. Netpbm is a toolkit for manipulation of graphic images, including conversion of images between varieties of different formats. Netpbm may be run to convert the image to one of many graphical image formats such as bmp. Bmp is the short form for bitmap image and is the preferred format of one embodiment. This type is a historic image format but commonly used on desktop computers. Once the bitmap-converted image is produced, a storage medium loading utility may be invoked to load the prepared image onto the storage medium 22. The image file sizes may vary from 1 or 2 Megabytes (MB) to 20 or 30 MB. The customer may be required to download the same picture to one or more storage mediums for a given order. This may require several storage mediums to be loaded at the same time.

Knoppix, an open-source software distributor, provides a Linux operating system in bootable Compact Disk Read Only Memory (CDROM) disks. This allows a computer system to boot with the operating system from the CDROM, auto detect the hardware, and set up a Linux file system in Random Access Memory (RAM). Programs are then made available to load from the CDROM, thus, enabling a computer on the front end 50 to run like a normal system would, had the operating system been installed on the computer's hard disk. To use a Knoppix Linux software distribution, a computer system requires at least 256 M of RAM. The software may access File Allocation Table (FAT) and Windows NT File System (NTFS) file systems as well as most networked storage types. In an effort to prevent unauthorized image replication, a customized version of the Knoppix CDROM is provided to allow staff 48 to securely load images 24 to compact flash storage at pre-defined memory locations. Staff 48 are the only personnel in possession of this CDROM. Therefore, only staff 48 have the ability to operate a computing system employing this particular image loading enablement. Furthermore, security of the image may be employed by encrypting the image just prior to loading it to the storage medium.

Other format conversion and loading utilities may also be used. One conversion utility example is the use of a desktop publishing application with similar conversion capabilities embedded in the application. One such application is Adobe Photoshop. Though not as amiable to automation, the application produces similar conversion results. As in most desktop publishing applications, the conversion is performed by menu-driven operations wherein the user reads a file in one format and saves it another format. However, scriptable, command-line utility such as Netpbm or its kind is a better way for automation. There are a variety of publicly available and producible loading utilities. One may craft a loading utility to read the converted file in popular programming languages such as Perl, C and C++, Python. In fact, one may even craft both the conversion and loading capabilities using these languages, or a combination thereof, in the form of a command line script or a Graphical User Interface-based (GUI-based) application. The GUI-based application may also leverage GUI frameworks such as wxwidgets.

3. Storage Medium

In the illustrated embodiment, the storage medium 22 is a commercially available media card such as compact flash. The medium 22 functions with no file system and data representing the image 24 is in raw format. The format has an implicit security feature since a computer system may detect the data but may not be able to interpret it correctly.

4. Display Assembly

The display assembly 18 is a device dedicated for visual artworks display. It displays images 24 provided through storage medium 22 of type compact flash. As shown in FIG. 5, the assembly 18 has the following subassemblies: a frame 108, a display panel 100, display driver 102, a controller 106, and a power source 104.

These subassemblies are housed in an industrial type metal enclosure commonly called a chassis. The chassis holds all subassemblies together allowing for component interaction to be harmonious and continuous. The chassis also has provisions for mounting of the assembly 18 to a wall or ceiling in portrait or landscape orientation. In addition, the design may have a special tamper proof bracket for wall mounting. There are allowances for mounting a bezel or frame 108 to the front surface. Mounting may optionally have considerations for display dimming capability, and recessed mounting options while retaining flash card accessibility. The chassis may feature a power switch as well as accessibility to service controls such as brightness and contrast. Optionally, an Ethernet connection with corresponding electronics may be considered. The chassis mechanical structure of an input device 300 provides for easy storage medium 22 insertion and release. One power cord extends from the chassis. Wall mounting may be such that the display assembly is not easily removed when displayed in an unsecured commercial area. Moreover, the chassis may have the ability to change and remove a frame. The display may also be covered by a protective panel to prevent damage from cleaning solution and other liquids, human fingerprints, sharp objects, and other potentially damaging sources.

4.1 Display Driver

The display driver 102 is an inverter used to power the Cold Cathode Fluorescent Lamps (CCFL) in a Liquid Crystal Display (LCD) panel. It is responsible for ignition, power down and power maintenance for driving of the display panel 100. This subassembly accepts +12 Volts Direct Current (VDC) and generates a high voltage to ignite the CCFL's of the LCD. The input voltage range is 10 VDC to 13.2 VDC. There are three LCD display panels supported: a 15-inch LCD with Extended Graphics Array 1024×768 resolution (XGA) and 24-Bit color (NEC NL10276BC30-10), 19-inch LCD with 1280×1024 standard resolution (SXGA) and 24-Bit color (FUJITSU FLC48SXC8V-10), and a 23-inch LCD with ultra-high quality 1600×1200 resolution (UXGA) and 24-Bit color (FUJITSU FLC59UXC8V-02 A).

In one embodiment, commercially available inverters from Spectrah Dynamics are used as the display driver. To drive the 15-inch and the 19-inch display panel, the Spectrah INV2-133260 and INV4-132375 inverter are used respectively. The inverter is integrated into the 23-inch display so no separate inverter is necessary for this display. For the 15-inch LCD, the typical output voltage is 1300 Volts Room Mean Square (RMS). The typical output voltage for the 19-inch LCD is 750 Volts RMS.

4.2 Controller

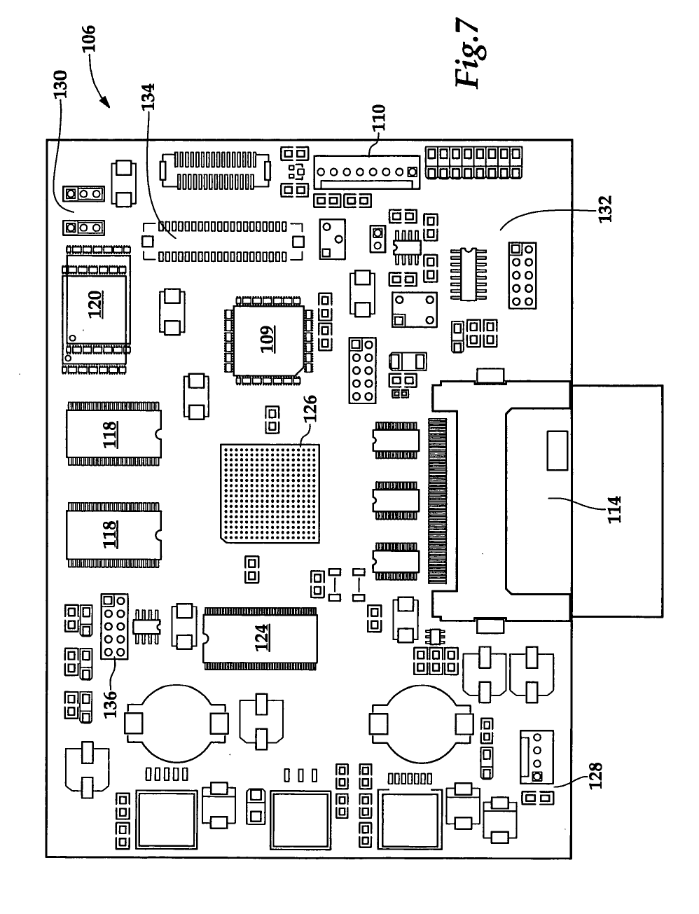

FIG. 7 illustrates one example of the board for the controller 106. The purpose of the board is to read an image from a removable compact flash (CF) card and display the image onto a Liquid Crystal Display panel of a customer-selected size. This special-purpose, single board, embedded controller 106 is the device's nerve center. Its responsibilities include power management and conditioning, and initialization to a state that sets the controller 106 ready to verify the image 24 from the compact flash. Power management and conditioning are shown at 128. It responds as a media reader processing one or more images 24 stored within the medium 22, and actuating the driver 102 in order to display one or more images. Commercially available inverters may be connected to the controller via using an LCD Inverter connector 110. A converter 109 is used to convert Transistor-Transistor Logic (TTL) signals to Low Voltage Differential Signaling (LVDS) for driving a connected inverter. In the cases where an inverter in integrated into an LCD display a connection between the controller and the display is provided by an LVDS connector 134. The controller 106 authenticates the image 24 from an inserted compact flash. The controller 106 reads the data's “key” and determines whether it matches the assembly's identity. Upon successful authentication, the controller 106 processes and constructs a valid image 24 for display.

For this controller 106, firmware resides in flash 120 and executes from Static Random Access Memory (SRAM) 118. The firmware does not use an operating system. However, operating systems such as VRTX by Mentor Graphics, Wind River's pSOS and the like may be used. The firmware checks to see if a valid compact flash card is inserted into the socket 114 when power is first applied to the board,. If a card is inserted, the board will access the image from the card, decrypt it and sends it to the LCD 100. The board may only accept properly encrypted images stored on the compact flash, hence, rejecting all others. While the image is being read, a message indicating a reading state may be displayed on the LCD 100. After 10 to 20 seconds, the image will appear on the display and remain there until the compact flash card is removed or until power is removed from the board. If the compact flash card is removed while the board is powered, a custom logo is displayed on the LCD. This custom 800×600 24-Bit color logo resides in the board memory and is replicable using a special compact flash card which contains the replacement logo. If the Board is powered up without a compact flash card or with an invalid card, the logo is immediately displayed on the LCD. Once powered up, the user can change images by swapping a valid compact flash card.

Diagnostic information regarding the board status and the image loading process is transmitted out the on-board serial port 132 which includes a serial header and one or more light emitting diodes (LEDs). This transmission could be disabled via a change in the firmware. In addition, there may be factory settable jumpers 130 which can be used to maximize the resolution between the image stored on the compact flash and the LCD.

The board is controlled by an embedded 32-bit NIOS processor inside the Altera Field Programmable Gate Array (FPGA) 126. There are jumpers 136 for FPGA 126 and memory configuration. The NIOS processor boots from a flash non-volatile memory 120 and runs program and data out of SRAM 118. The image is read from the compact flash card, decrypted and temporarily stored one line at a time into the SRAM 118. Once a valid line of the image is built, it is transferred via a custom SDRAM (Synchronous Dynamic Random Access Memory) controller (also housed inside the FPGA) to the SDRAM 124. After the entire image, including a logo, has been built and stored in the SDRAM frame buffer, the processor enables the custom LCD controller which then sends the image to the LCD.

This board design was based off of the Altera NIOS Cyclone EP1C20 Evaluation Board. Altera Corporation of San Jose, Calif. provided the FPGA 126 which comprises a NIOS processor, an SDRAM controller, LCD controller, Serial interface, Compact Flash interface, and Flash interface. Altera Corporation also provided code to support the Flash and Serial Interfaces. The SDRAM controller was customized to support full page-mode access. The standard SDRAM controller supplied by Altera could not be used in this design because it called for the SDRAM to run at the same speed as the NIOS processor which runs at 50 Mhz. This design called for the SDRAM controller to run at 100 Mhz to be able to support the desired image bandwidth. This speed is dictated by the need to support the image bandwidth for the 23-inch LCD via the following calculation:
1600×1200×3=5,760,000 bytes/frame
5,760,000 bytes/frame×60 frames/second=345,600,000 bytes/second
Hence, to support the 23″ panel, the design must have more that 345 Megabytes of bandwidth. Given that the board's SDRAM 124 is 32 bits wide (4 bytes) and is specified at 100 MHz, the theoretical bandwidth is number of bytes×clock rate:
(100,000,000×4 bytes)/second=400,000,000 bytes/second
For a 66 Mhz SDRAM the theoretical bandwidth is:
(66,000,000×4 bytes)/second=264,000,000 bytes/second
For a 50 Mhz SDRAM the theoretical bandwidth is:
(50,000,000×4 bytes)/second=200,000,000 bytes/second

Since these bandwidths are only theoretical, the design calls for the memory bandwidth to be sufficiently greater than the requirement of 345,600,000 bytes/second. Hence the 100 MHz SDRAM was chosen.

To meet this 100 MHz rate, a custom SDRAM controller was designed to initialize the SDRAM 124, and allow the 100 Mhz LCD controller to read image data while allowing the slower NIOS processor the capability to read and write to the SDRAM. The FPGA 126 outputs standard TTL data to the TTL-LVDS converter chip 109. This data is then converted to LVDS (Low Voltage Differential Signaling) and is then transmitted to the LCD 100.

Of interest is the following image bandwidth calculation for the remaining displays:

The image bandwidth for an 18-inch LCD is:
1280×1024×3=3,932,160 bytes/frame
60 frames/second=235,929,600 bytes/second
The image bandwidth for aa 15-inch LCD is:
1024×768×3=2,359,296 bytes/frame
60 frames/second=141,557,760 bytes/frame

The above calculations theoretically show that lower speeds of memory (66 MHz SDRAM for example) may perhaps be used in another embodiment. These other embodiments, however, would only support the lower image bandwidth displays.

4.2.1 Detailed Controller Design

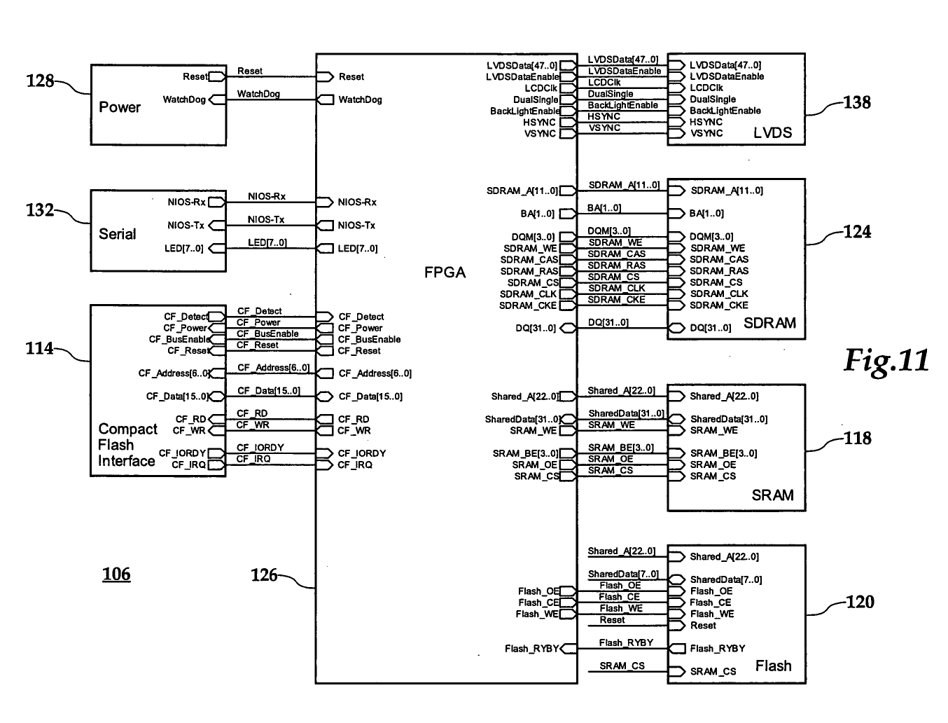

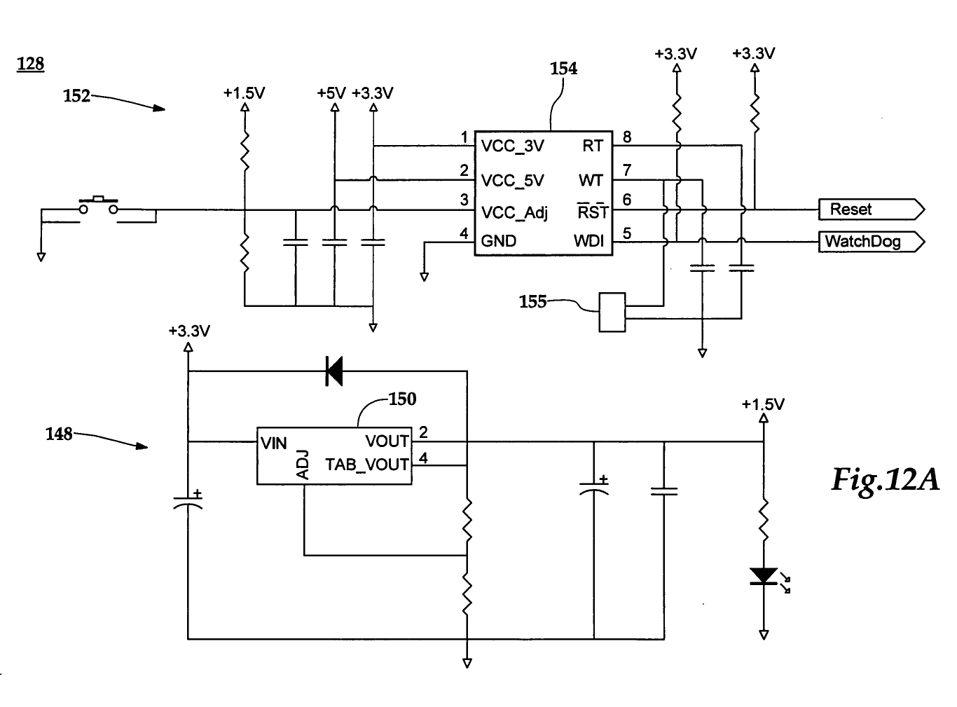

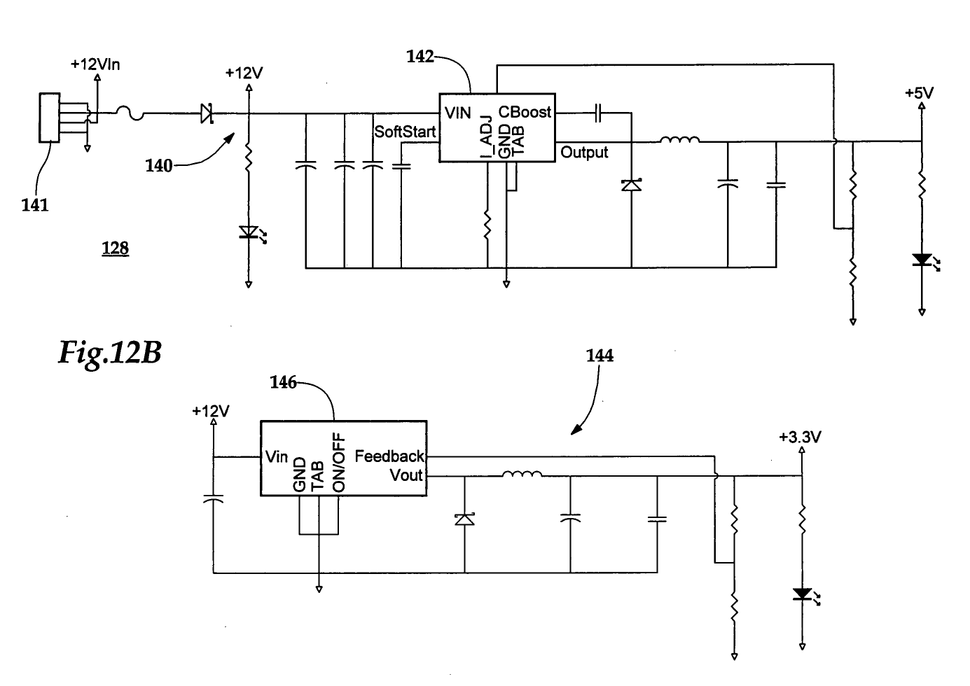

FIG. 11 is a block diagram overview of the major sub-systems making up the controller 106. All of the controller components are based around a dedicated Field Programmable Gate Array (FPGA) 126. The sub-systems surrounding the FPGA 126 are power circuitry 128, a serial interface for on-board diagnostics 132, a compact flash interface 114, circuitry 138 for LVDS compatibility, SDRAM 124 for image storage, SRAM 118 for program and data memory, and Flash non-volatile storage 120. Each sub-system is broken down into their respective details. These are illustrated in FIGS. 12 through 20.

FIGS. 12A and 12B depict circuitry for power conditioning and management 128. Power supply circuitry is shown as 140, 144 (see FIG. 12B) and 148 (see FIG. 12A). The 5 Amperage (A) supply circuit 140 has an input power connector 141 and a step-down voltage regulator 142 of type designated LM2679S-5.0. The 3 A supply circuit 148 has a low dropout positive regulator 150 of type designated LM1085IS-ADJ. A power converter and step down voltage regulator-based circuit 144 uses a regulator 146 of type designated LM2596S-ADJ. Also shown in FIG. 12A is the circuit for reset and watchdog timeout operations 152. This circuit uses a triple point supply adjustable monitor 154 of type designated LTC1726-5. A jumper 155 provides watchdog enable and disable capability.

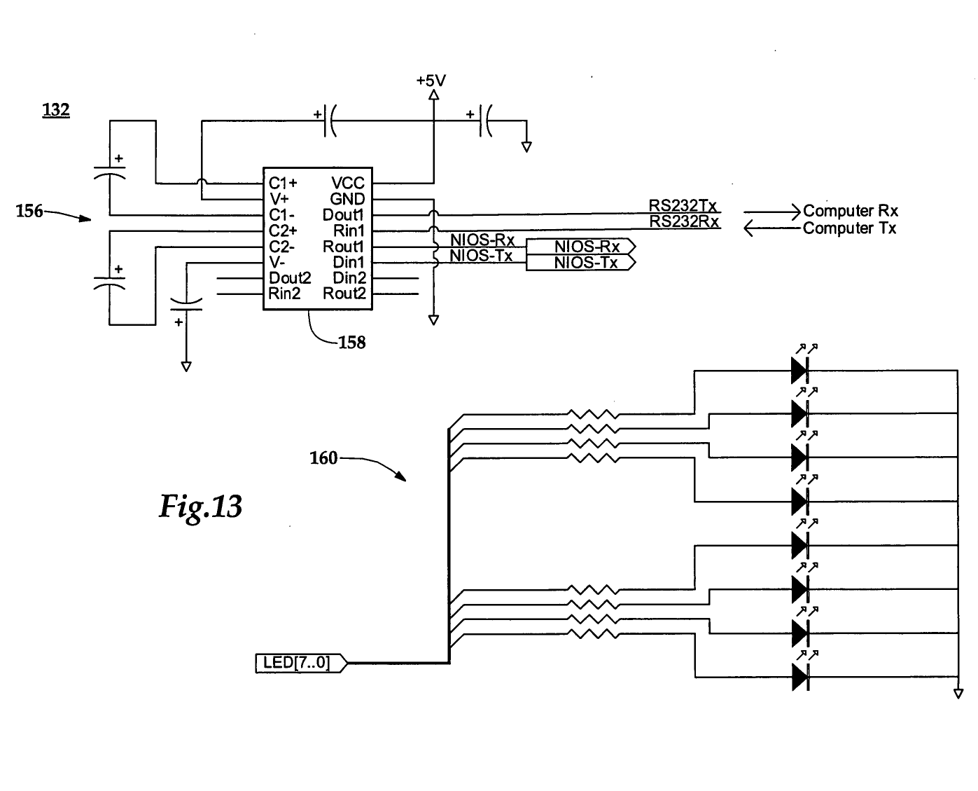

FIG. 13 is schematic of the Serial sub-system 132. The serial interface 156 is implemented using a low power, +5V dual driver receiver 158 of type designated DS14C232. Also, a set of Light Emitting Diodes 160 is used for diagnostic monitoring.

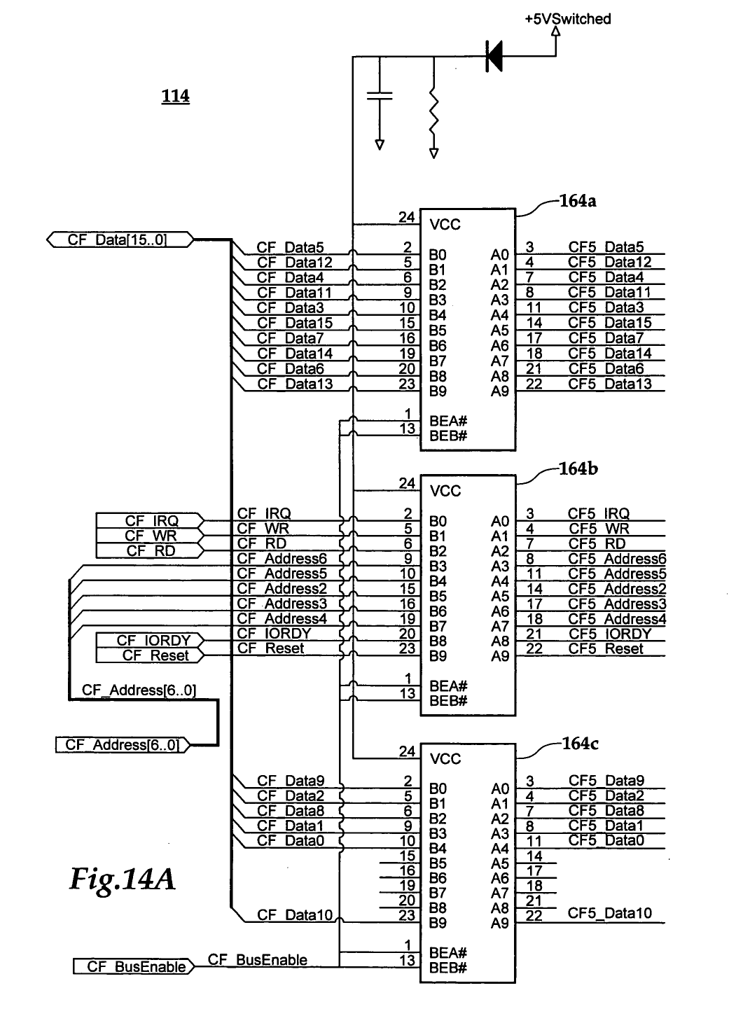

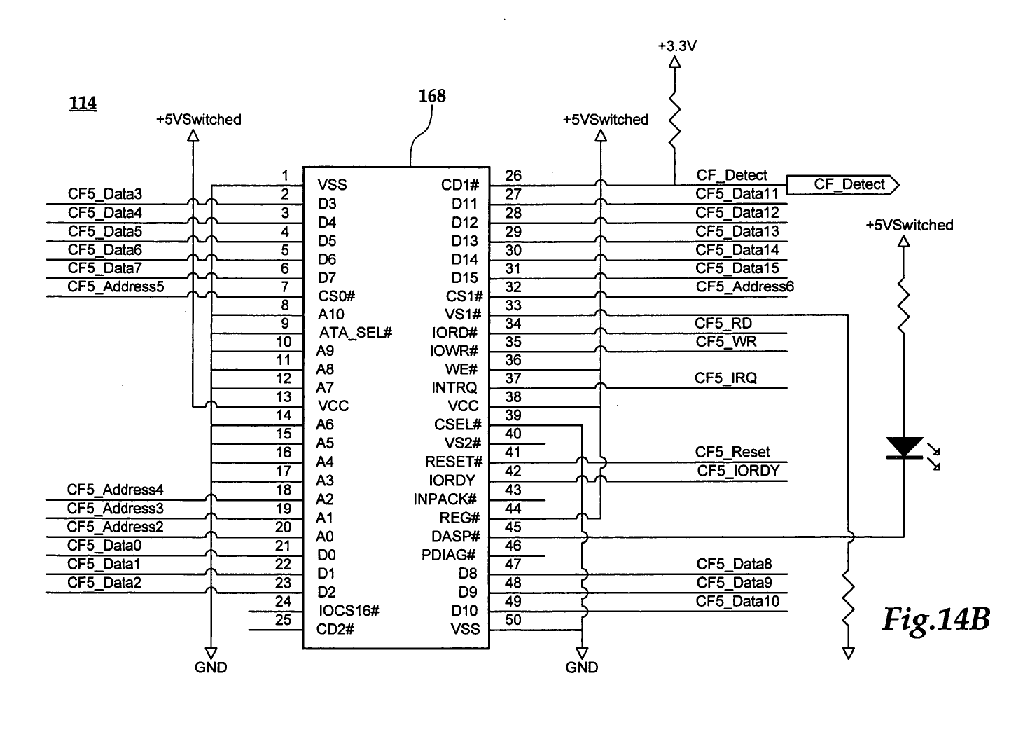

FIGS. 14A, 14B and 14C are a schematic of the Compact Flash Interface 114 sub-system. The interface is built with an integrated load switch 162 (see FIG. 14C) of type designated FDC6323L, three 10-Bit, Bus switches 164a, 164b, 164c (see FIG. 14A) all of which are of the type designated PI5C3384, and a compact flash header 168 (see FIG. 14B) used to mate with a compact flash card.

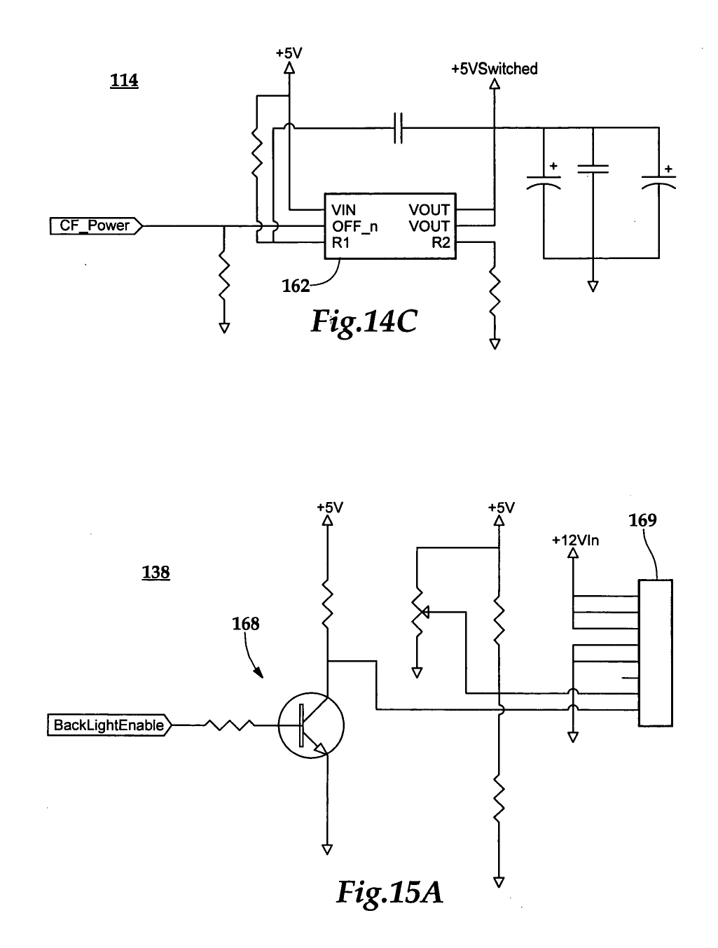

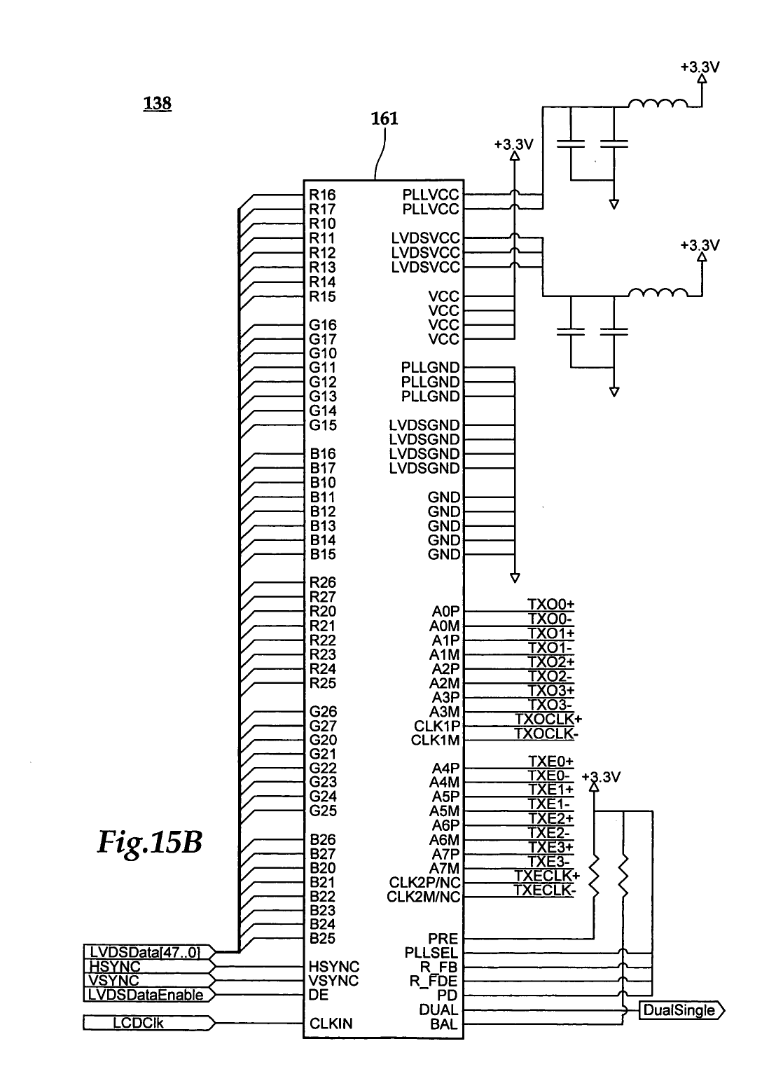

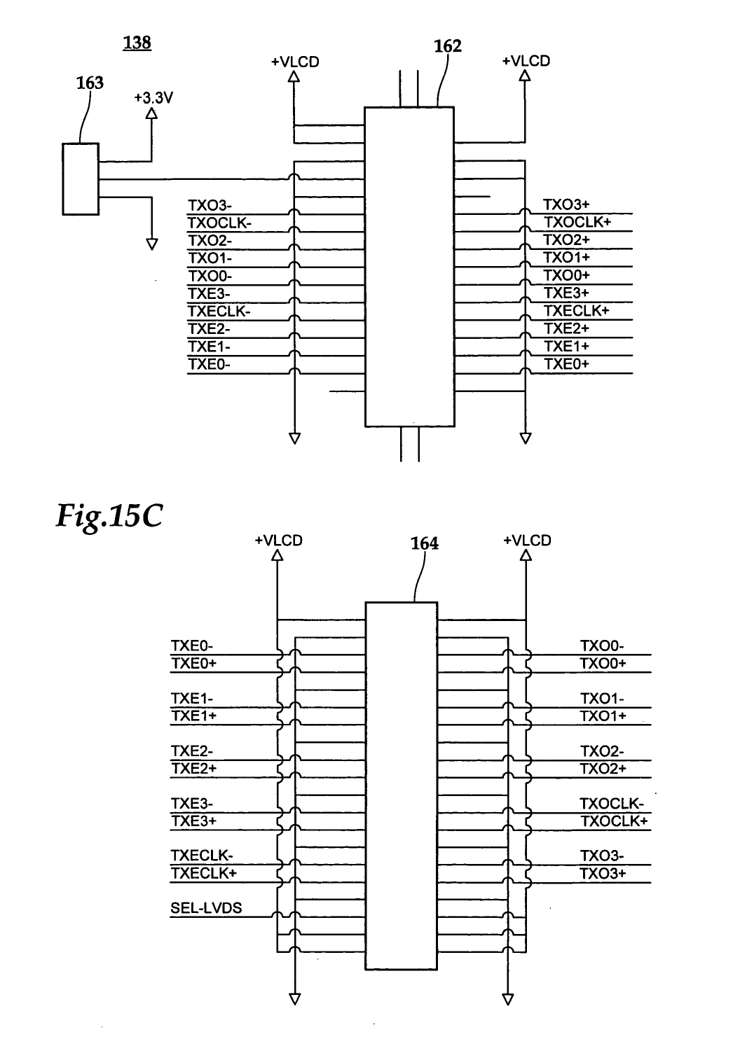

FIGS. 15A, 15B and 15C are a schematic of the to Low Voltage Differential Signaling (LVDS) sub-system 138. Electronically interfacing the controller to the display is accomplished using a +3.3V Dual Pixel LVDS Display Interface 161 (see FIG. 15B) of type designated DS90C387. Two mechanical connections to the display are provided as shown in FIG. 15C. An LCD display may be connected using a 40-pin LVDS connector 164 of type designated DF13-40DP-1.25V. An alternate connection may be provided in an optional provision 162 which is coupled with an VDS Mapping jumper 163. The backlighting for an LCD display may be controlled through a circuit for backlight enable and brightness level control 168 (see FIG. 15A). A header connection to the backlight enable and brightness level control signals is also provided 169.

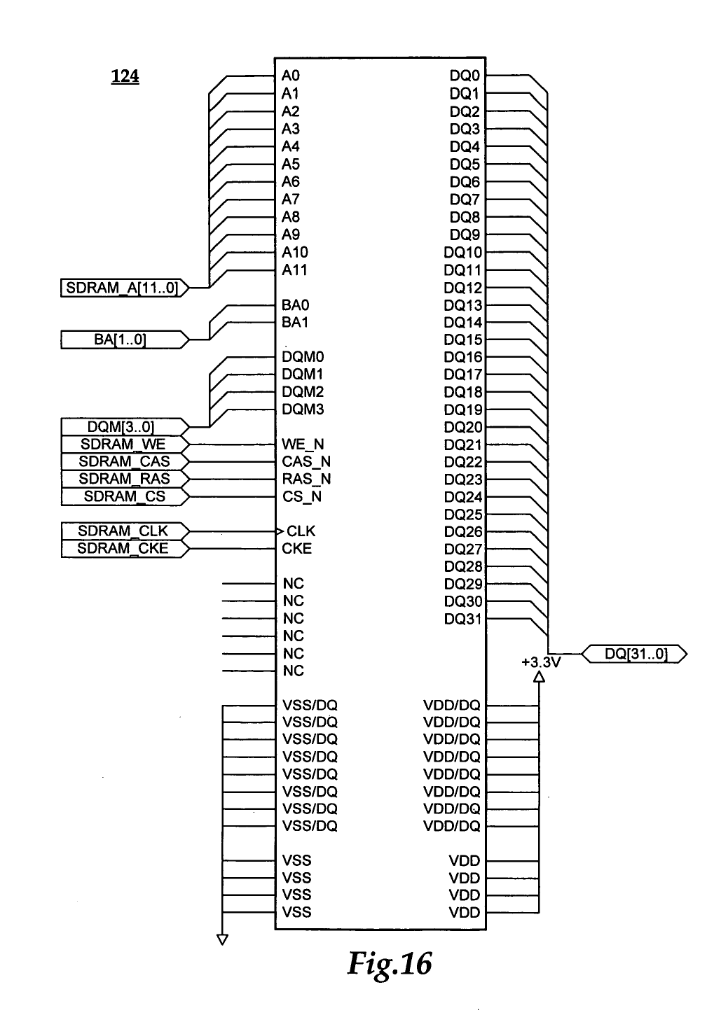

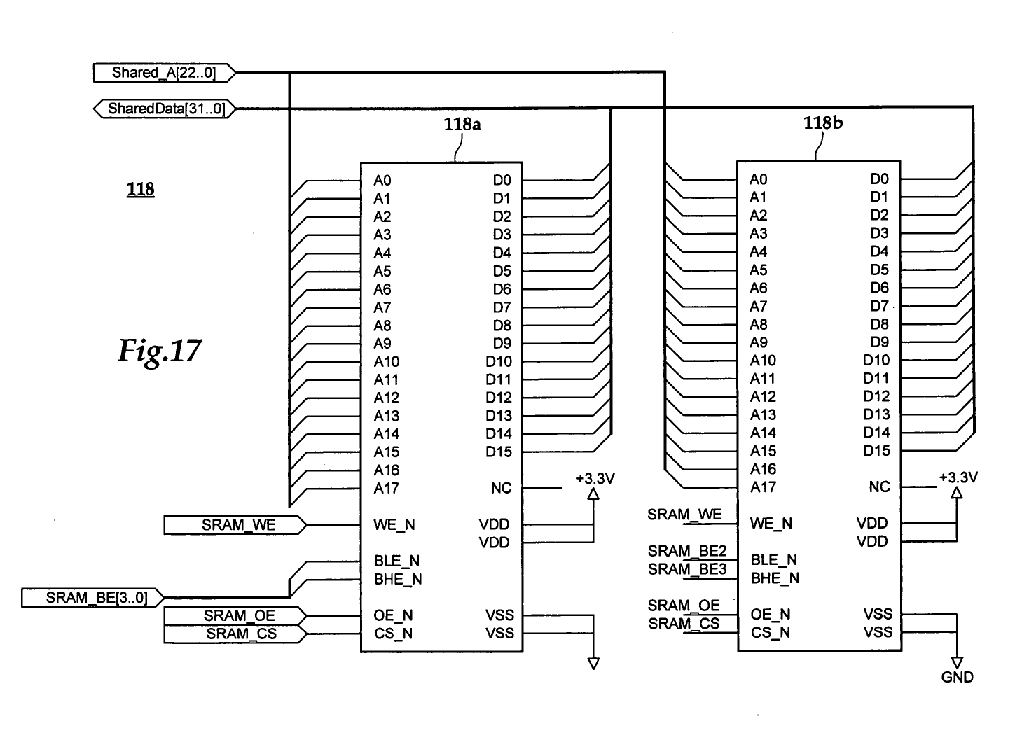

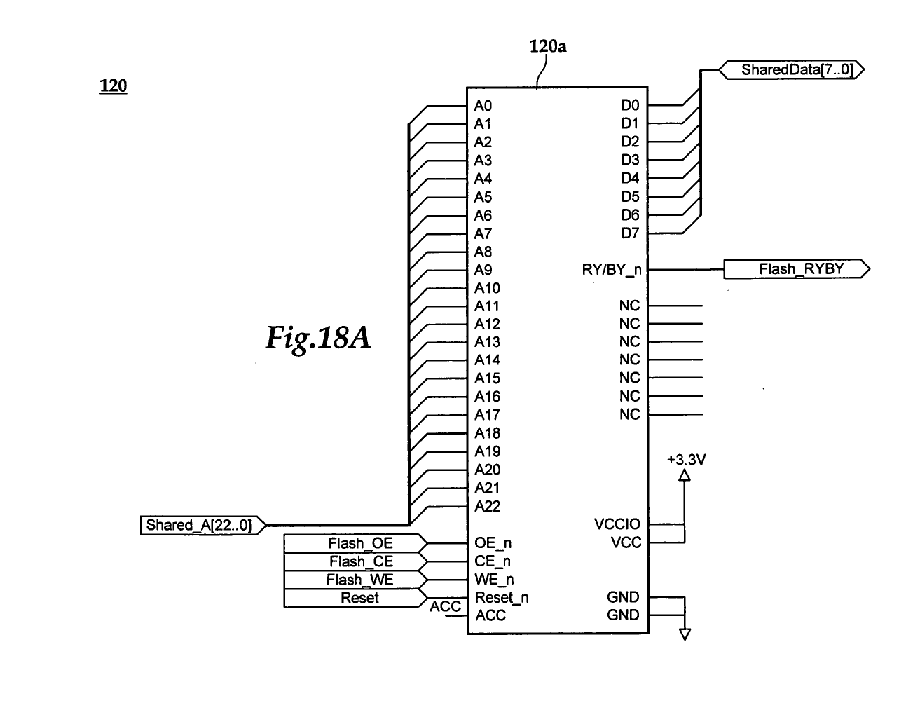

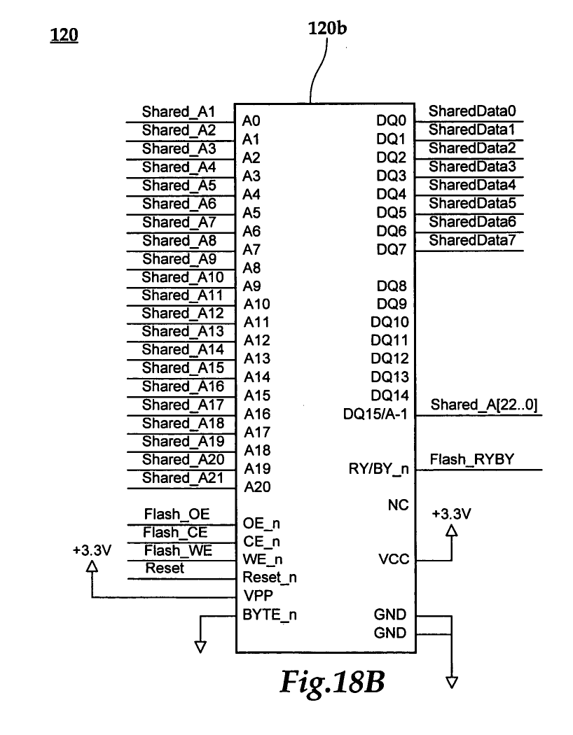

On-board memory, as shown in FIG. 16, FIG. 17, FIG. 18A, and FIG. 18B, is used for accessing default resources such as a logo, boot loader operations, image construction, frame buffering, and program execution. This is accomplished using Static Random Access Memory (SRAM) and Synchronous Dynamic Random Access Memory (SDRAM), and non-volatile flash memory. FIG. 16 is schematic of the SDRAM sub-system 124. This system uses SDRAM of type designated MT48LC4M32B2. FIG. 17 is schematic of the SRAM sub-system 118. In this sub-system, 1 Megabytes of SRAM organized as two 256×16 parts 118a and 118b. These parts are of type designated IDT71V416S.

FIGS. 18A and 18B are a schematic of the Flash sub-system. Boot loader operations reside in Flash. In addition, the Flash sub-system 120 holds the firmware used to instruct the controller 106 to properly decode and display the image 24, handle the case where the compact flash is inserted but no image is available, and manage power-up and power-down behavior. The Flash sub-system 120 also provides memory for a stand-by, corporate “logo”. It uses 64 Megabit (Mbit), 3.0 Volt (3 Volts to 3.6 Volts) single power supply flash memory 120a (see FIG. 18A) of type designated AM29LV065D. An alternate flash memory choice is also shown 102b (see FIG. 18B). This part is a 2.7-volt 32-megabit flash memory of type designated AT49BV322A.

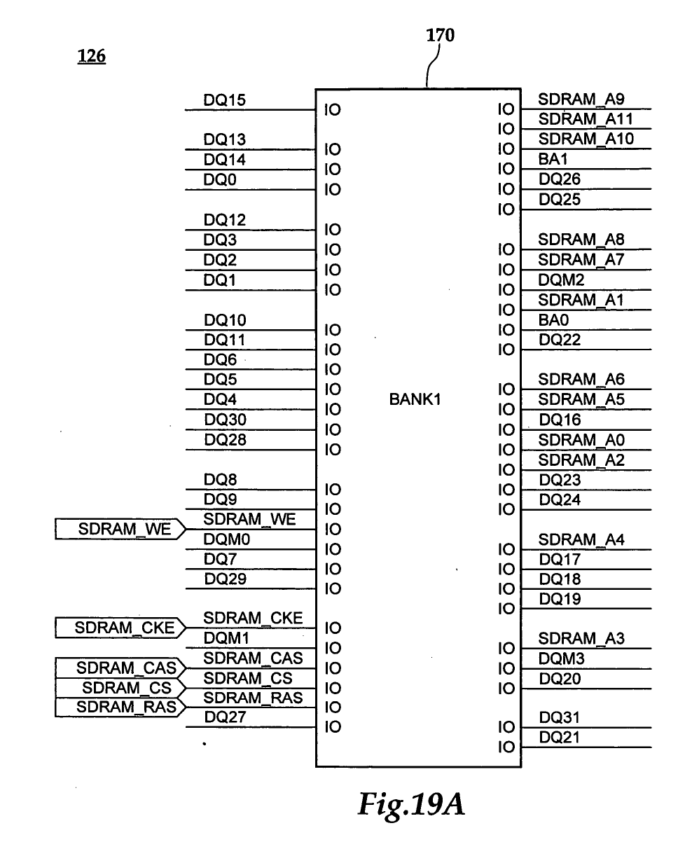

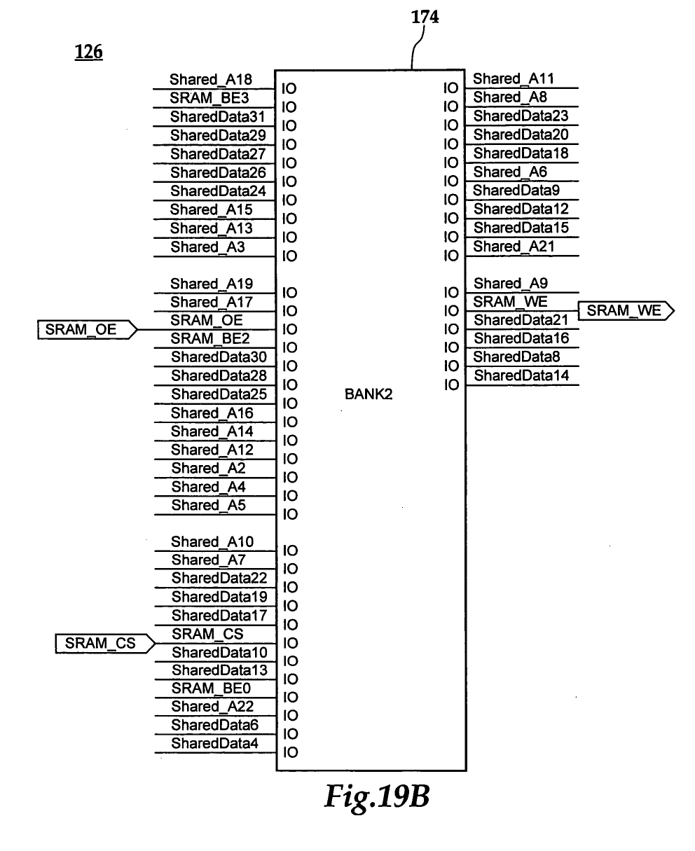

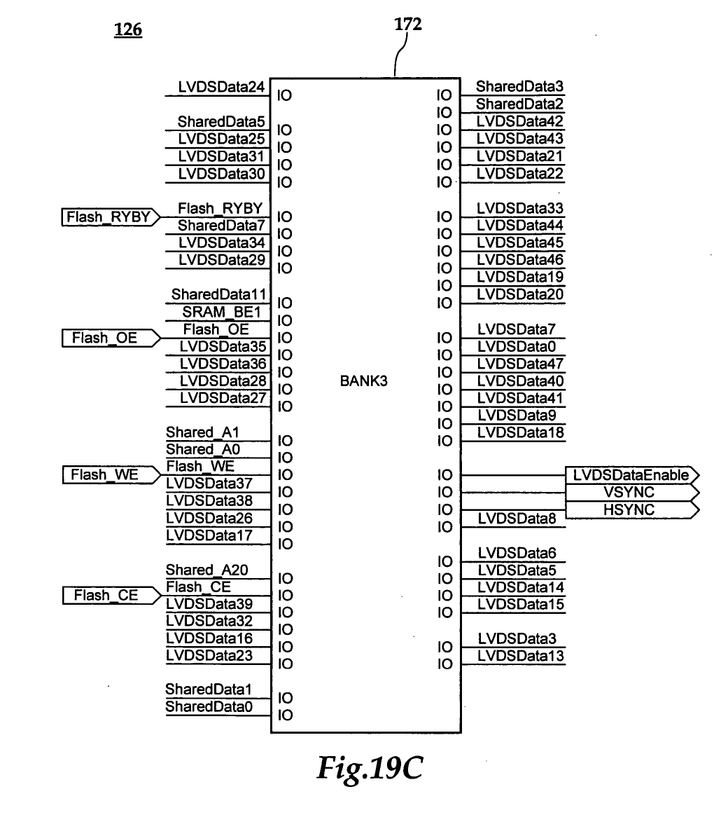

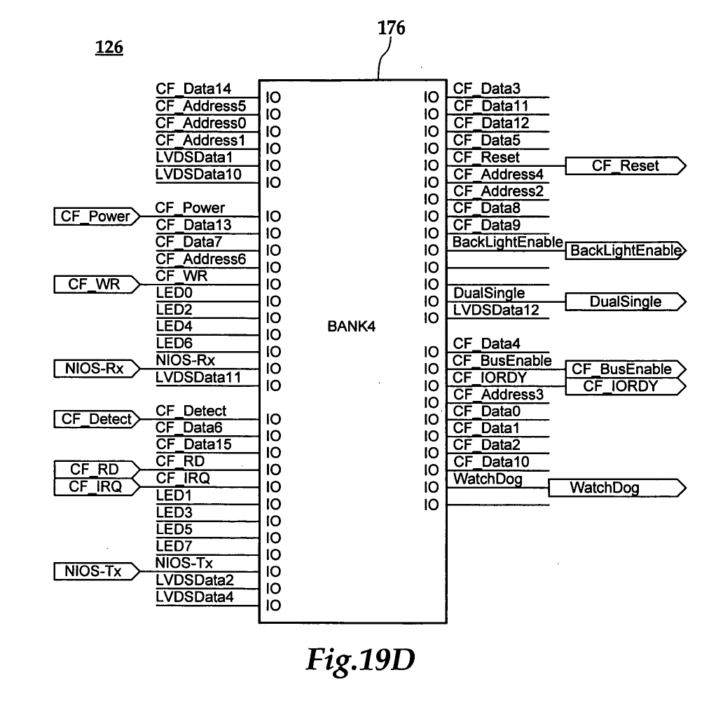

FIGS. 19A, 19B, 19C and 19D depict detailed connectivity between the Field Programmable Gate Array (FPGA) 126 and the other sub-systems. The FPGA device of type EP1C20F324 is shown in four sections: Bank1 170, Bank2 174, Bank3 172, and Bank4 176.

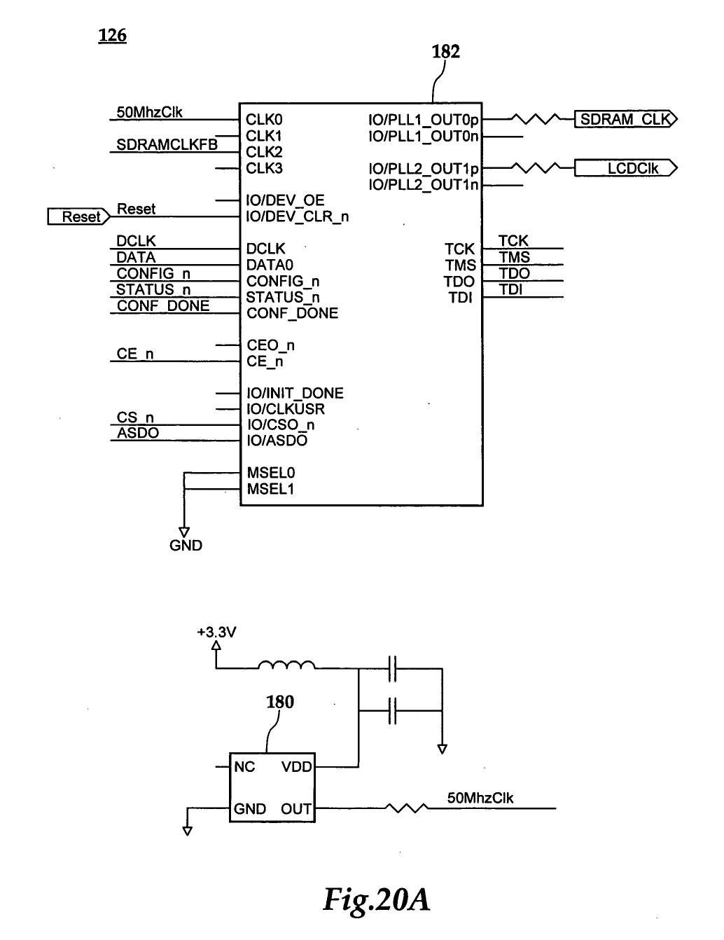

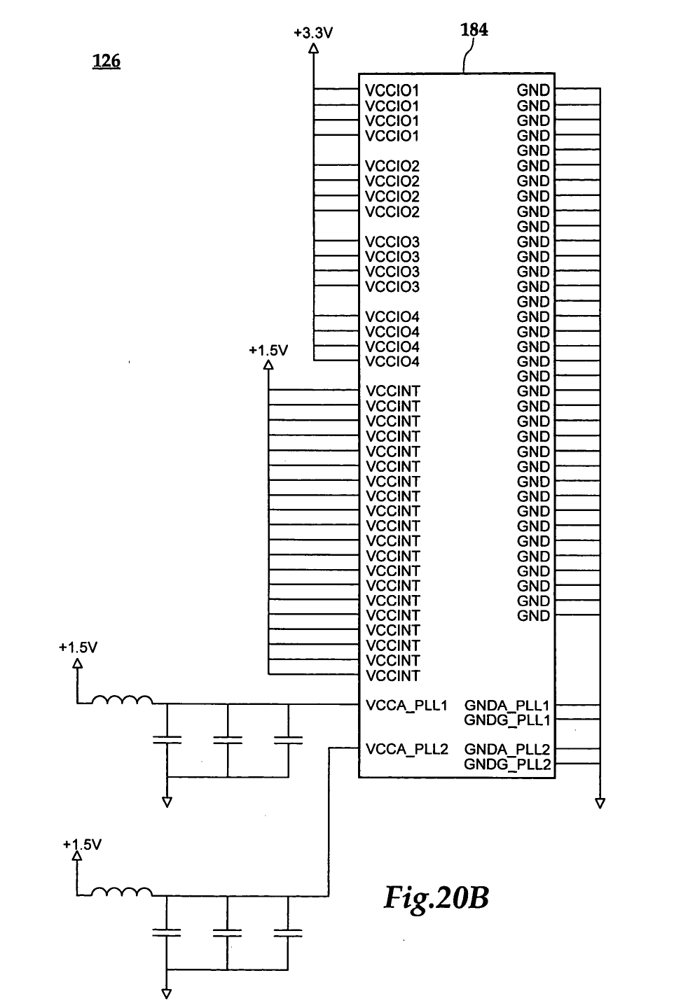

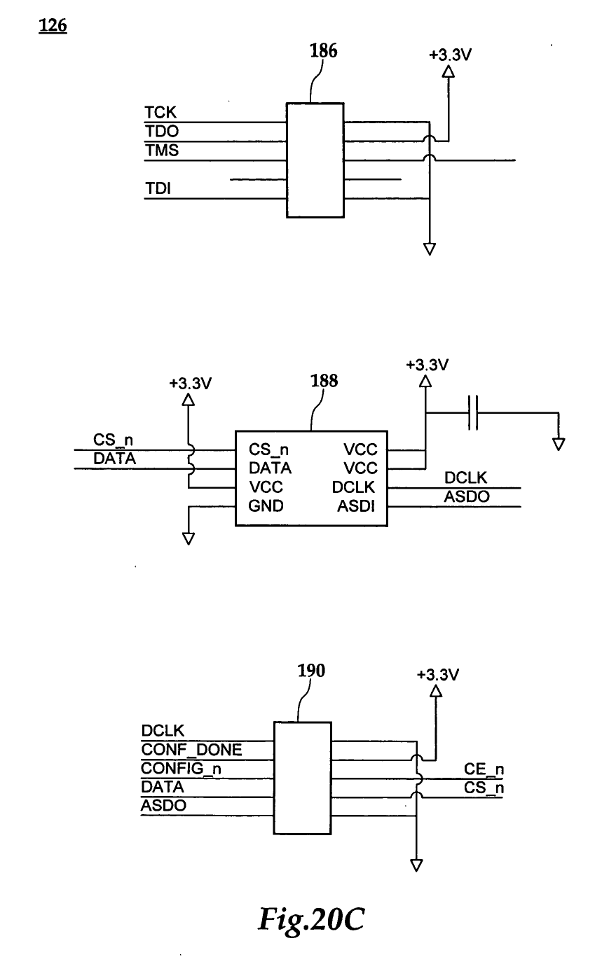

FIGS. 20A, 20B and 20C are a schematic of the connection scheme for FPGA programming and operation. The remaining circuitry which interfaces with the FPGA is shown. As shown in FIG. 20A, a 3.3 Volts clock source 180 provides the FPGA 126 with the 50 MHz clock frequency. This clock frequency is input to the power, configuration and clock control section 182 of the FPGA. Note that FPGA power and ground lines are connected as shown in 184 (see FIG. 20B).

FIG. 20C also illustrates varied provisions for controller firmware programming. One programming method is depicted using a Joint Test Action Group (JTAG) programming as shown in 186. This interface 186 may also be used for controller development and debugging purposes. Another method may be employed through active serial programming. This may be accomplished using a serial configuration device 188 of type designated EPCS4 and a serial programming header 190.

4.3 Display

As one example, the assembly 18 may be ordered with a display panel 100, such as an LCD type, in one of three sizes: 15-inch, 19-inch and 23-inch. In the illustrated embodiment, display panels are model NL10276BC30-10 (15-inch) from NEC Corporation and models FLC48SXC8V-10 (19-inch) and FLC59UXC8V-02 A (23-inch) from Fujitsu Corporation. A fitted, aesthetically-pleasing frame 108 also accompanies each display panel 100. Each panel uses active matrix thin-film-transistor (TFT) technology to produce the best possible color and true image representation. Each has high color depth, wide viewing angles, high light output, and good contrast ratios. These display panels use 8-bit LVDS signals interface technology to transfer data to their internal electronics. This provides a basis for, as an example, 16.7M colors. The actual memory to support a specific image 24 does not require all 16.7M colors. However, assembly 18 memory affords more than what is needed to insure that the display panel 100 has the ability to resolve the fine details of color at each pixel location. The memory required for the 1600×1200 pixel resolution image on a 23″ LCD display panel 100 is calculated as follows:

Horizontal pixel resolution times the vertical pixel resolution
1600×1200=1,920,000 times the Red, Green, Blue (RGB) element of the pixel
1,920,000×3=5,760,000 or 5.76 MB

For 15″ display panel 100 with resolution of 1024×768, the calculation is:
1024×768×3=2,359,296 or 2.36 MB file size

For 19″ display panel 100 with resolution of 1280×1024, the calculation is:
1280×1024×3=3,932,160 or 3.92 MB

As per this pixel resolution calculation example, 12.04 MB is, therefore, the sum of the individual memory required for 3 images on a single disk. Having 16 MB as minimum size compact flash provides all the space required. Extra memory on the controller 106 is required to store and then display the logo and company name when no images are available. This example assumes a company logo of 2 MB or less. A total of the 8 Megs of RAM is available for the controller 106. This accommodates maximum image memory for the 23″ display panel 100 plus the 2 MB company logo capacity.

4.4 Power Source

The power source 104 (see FIG. 5) supplies operating power that converts the AC line voltage to low DC voltage for powering the display driver 102, panel and controller 106. It accepts 110 AC line voltage and converts it to +12 VDC for the other subassemblies. The 12 VCD is the typical voltage. The source has an output voltage range of approximately 10 VDC to about 13.2 VCD. The input AC voltage range is a broad 90 VAC to 264 VAC to accommodate voltages in the Japan, US and Europe.

In one embodiment, a commercially available 45 Watts power source is used for the 15-inch and 19-inch display panel. This is supplied as the CUP45 Series by XPiQ, Inc. For the 23-inch LCD, a commercial 100 Watts power source is used. This power source is also from XPiQ, Inc. and goes by the model name AED 100 Series. These sources may optionally be enclosed in the chassis.

5. Summary

What has been described is a method and a system for enabling the exposure, distribution and presentation of high quality digital representations of images of visual art works to customers. While in the description, numerous specific details are set forth to provide a thorough understanding of the present invention, it is apparent to one skilled in the art that, having read the description, the present invention may be practiced without some or all of these specific details.

Other alternatives and substitutions as may occur upon reading the foregoing are to be understood as falling within the scope of the invention as defined by the claims which follow.

1. A method for enabling exposure, distribution and presentation of high quality digital representations of images of visual art works to customers, said method comprising:
providing infrastructure for storage, management, selection and retrieval of one or more of said images in a high resolution, full screen format;
transferring a selected image to a portable storage medium;
distributing said storage medium to a customer;
reading said image from said storage medium; and
displaying said image on a display panel in a high resolution, full screen format.

2. A method according to claim 1, further comprising viewing by a customer of one or more of said images from an internet terminal.

3. A method according to claim 1, further comprising viewing by a customer of one or more of said images from a catalog.

4. A method according to claim 2, wherein said viewing is performed by displaying said images in a plurality of groupings for customer search and image selection purposes.

5. A method according to claim 1, further comprising administering business information in said infrastructure using customer and product databases.

6. A method according to claim 1, further comprising providing a mechanism in said infrastructure for order processing of customer-selected images.

7. A method according to claim 1, further comprising providing a mechanism in said infrastructure for product marketing analysis.

8. A method according to claim 1 wherein said providing infrastructure is performed in a heterogeneous database environment.

9. A method according to claim 8 further comprising extending said heterogeneous database environment for a plurality of partner databases.

10. A method according to claim 1 wherein said transferring a selected image to a storage medium comprises transferring a selected image to a media card.

11. A method according to claim 1 wherein said transferring and displaying provide true proportion relative to a selected size of said display panel.

12. A dedicated system for enabling exposure, distribution and presentation of high quality digital representations of images of visual art works to customers, said system comprising:
a display panel;
and
a special-purpose single-board computer housed in an enclosure and comprising a custom-designed embedded controller, a power source, a display driver and a media reader, for reading said images from a storage medium and displaying said images on said display panel in a high resolution, full screen format.

13. A system according to claim 12, wherein said single board computer accepts said storage medium at said reader and processes at least one of said images stored within said medium and actuates said driver in order to display said at least one of said images.

14. A system according to claim 12, wherein said power source includes delivery means for providing operating power to said reader, said controller and said display driver.

15. A system according to claim 12, wherein said display driver includes ignition means, power down means and power maintenance means for driving said display panel.

16. A system according to claim 12, wherein said display panel is of selectable size.

17. A system according to claim 16, wherein said image is stored and displayed in true proportion relative to a selected size of said display panel while maintaining said high quality of image representation.

18. A system for enabling exposure, distribution and presentation of high quality digital representations of images of visual art works to customers, said system comprising:
means for providing infrastructure for storage, management and retrieval of one or more of said images in a high resolution, full screen format;
means for transferring a selected image to a portable storage medium;
means for distributing said storage medium to a customer,
means for reading said image from said storage medium; and
means for displaying said image on a display panel in a high resolution, full screen format.

19. A system according to claim 18, further comprising means for viewing by a customer one or more of said images from an Internet terminal.

20. A system according to claim 18, wherein said means for viewing comprises means for displaying said images in a plurality of groupings for customer search and image selection purposes.

21. A system according to claim 18, further comprising means for administering business information in said infrastructure using customer and product databases.

22. A system according to claim 18, further comprising means for providing a mechanism in said infrastructure for order processing of customer-selected images.

23. A system according to claim 18, further comprising means for providing a mechanism in said infrastructure for product marketing analysis.

24. A system according to claim 18 wherein said means for providing infrastructure for storage, management and retrieval comprise means for performing said storage, management and retrieval from a heterogeneous database environment.

25. A system according to claim 24 further comprising means for extending said database environment for a plurality of partner databases.

26. A system according to claim 18 wherein said means for transferring a selected image to a storage medium comprise means for transferring a selected image to a media card.

27. A system according to claim 18 wherein said means for transferring and said means for displaying include transferring and displaying said image in true proportion relative to a selected size of said display panel.

28. A method for enabling a customer to obtain and display high quality digital representations of images of visual art works, said method comprising:
obtaining a dedicated reader and a display panel for reading an image from a portable storage medium and displaying said image on said display panel in a high resolution, full screen format;
placing an order for said image;
receiving a portable storage medium containing said at least one image;
placing said storage medium into said dedicated reader; and
displaying said image via said dedicated reader on said display panel in a high resolution, full screen format.

29. A method according to claim 28, wherein said placing and order includes viewing by a customer one or more of said images from an Internet terminal.

30. A method according to claim 28, further comprising providing by a customer of billing and delivery information.

31. A method according to claim 28, further comprising
searching by a customer of a database of said images, and
selecting by a customer of at least one image from said data base.

32. A method according to claim 28, further comprising providing by a customer of an image to be transferred to said portable storage medium in a format for enabling said dedicated reader to display said image on said display panel in a high resolution, full screen format.

33. A system for enabling a customer to obtain and display high quality digital representations of images of visual art works, said system comprising:
means for reading an image from a portable storage medium and for displaying said image on a display panel at a given location in a high resolution, full screen format;
means for placing an order for a portable storage medium containing at least one image; and
means for obtaining said portable storage medium containing said at least one image at a location of said means for reading and said display panel.

34. A system according to claim 33, wherein said means for placing an order includes means for viewing by a customer of one or more of said images from an Internet terminal.

35. A system according to claim 33, further comprising means for providing by a customer of billing and delivery information.

36. A system according to claim 33, further comprising means for a customer
searching a database of said images, and
selecting at least one image from said data base.

37. A system according to claim 33, further comprising means for a customer providing an image to be transferred to said portable storage medium in a format for enabling display of said image on said display panel in a high resolution, full screen format.

38. A system according to claim 33 wherein said means for obtaining includes means for producing an ordered image on said storage medium in true proportion relative to a selected size of said display panel.
